(19) United States
(12) Patent Application Publication
(10) Pub. No.: US 2025/0229560 A1
(43) Pub. Date: Jul. 17, 2025

(54) DRAWING OBJECT AND METHOD OF FORMING DRAWING OBJECT

(71) Applicant: SONY GROUP CORPORATION, Tokyo (JP)

(72) Inventors: Satoko ASAOKA, Tokyo (JP); Yuki OISHI, Tokyo (JP); Kenichi KURIHARA, Tokyo (JP); Isao TAKAHASHI, Tokyo (JP)

(73) Assignee: SONY GROUP CORPORATION, Tokyo (JP)

(21) Appl. No.: 18/843,875

(22) PCT Filed: Mar. 16, 2023
(86) PCT No.: PCT/JP2023/010442

§ 371 Date: Sep. 4, 2024

(30) Foreign Application Priority Data
Mar. 17, 2022 (JP) 2022-042855

(51) Int. Cl. B41M 5/46; B41M 5/42

(52) U.S. Cl. CPC B41M 5/46; B41M 5/42; B41M 2205/18; B41M 2205/42

(57) ABSTRACT

A drawing object according to an embodiment of the present disclosure includes a stacked body including a plurality of heat-sensitive recording layers stacked with a heat-insulating layer interposed therebetween. The heat-sensitive recording layers are different from each other in color in a color-developed state and light absorption wavelength band. The plurality of heat-sensitive recording layers each has a striped pattern drawn as a drawing mark resulting from irradiating a surface of the drawing object with a laser light beam. The striped pattern extends in a first direction and has irregular widths.

### TECHNICAL FIELD

The present disclosure relates to a drawing object and a method of forming a drawing object.

### BACKGROUND ART

A recording medium on which reversible recording and erasing of information are performed by heat, that is, what is called a reversible heat-sensitive recording medium has been developed as a display medium in place of printed matters. In the reversible heat-sensitive recording medium, for example, a plurality of reversible heat-sensitive recording layers different from each other in photothermal conversion wavelength are stacked with a heat-insulating layer interposed therebetween. A reversible heat-sensitive recording medium is subjected to pulse irradiation with a laser light beam having a predetermined wavelength to selectively generate heat at a specific reversible heat-sensitive recording layer and allow the specific reversible heat-sensitive recording layer to be colored or decolored by the action of the generated heat, which allows for recording or erasing of information (see PTL 1, for example).

### CITATION LIST

### Patent Literature

PTL 1: Japanese Unexamined Patent Application Publication No. 2003-127446

### SUMMARY OF TIE INVENTION

Incidentally, in PTL 1, in a case where drawing is to be performed at a higher resolution on a reversible heat-sensitive recording medium, it is necessary to reduce an irradiation area per pixel and to perform irradiation with a laser light beam at a higher energy density. Meanwhile, a semiconductor laser is limited in power. Accordingly, an insufficiency of laser power can cause a problem that desired image quality is not obtainable. It is therefore desirable to provide a method of forming a drawing object that makes it possible to achieve high image quality with low power, and a drawing object formed by such a method.

A drawing object according to a first embodiment of the present disclosure includes a recording medium including a plurality of heat-sensitive recording layers stacked with a heat-insulating layer interposed between the plurality of heat-sensitive recording layers. The plurality of heat-sensitive recording layers is different from each other in color in a color-developed state and light absorption wavelength band. The plurality of heat-sensitive recording layers each has a striped pattern drawn as a drawing mark resulting from continuously irradiating a surface of the recording medium with a laser light beam in a scanning direction. The striped pattern extends in a first direction and has irregular widths.

In the drawing object according to the first embodiment of the present disclosure, the plurality of heat-sensitive recording layers each has the striped pattern drawn as the drawing mark resulting from continuously irradiating the surface of the recording medium with the laser light beam in the scanning direction. The striped pattern extends in the first direction and has the irregular widths. This allows for a high resolution in a second direction orthogonal to an extending direction of the striped pattern. Meanwhile, the resolution is lower in the first direction parallel to the extending direction of the striped pattern than in the second direction. However, in drawing by means of continuous irradiation of the laser light beam, it is possible to perform drawing by means of heat transfer. It is therefore possible to achieve desired image quality with low power, as compared with drawing by means of pulse irradiation with the laser light beam.

A method of forming a drawing object according to a second embodiment of the present disclosure is a method of forming a drawing object by performing laser irradiation on a recording medium. The recording medium includes a plurality of heat-sensitive recording layers stacked with a heat-insulating layer interposed between the plurality of heat-sensitive recording layers. The plurality of heat-sensitive recording layers is different from each other in color in a color-developed state and light absorption wavelength band. This forming method includes a drawing process of forming the drawing object by continuously irradiating the recording medium with a laser light beam in a scanning direction to form, as a drawing mark, a striped pattern on each of the plurality of heat-sensitive recording layers. The striped pattern extends in a first direction and has irregular widths.

In the method of forming the drawing object according to the second embodiment of the present disclosure, the drawing object is formed by continuously irradiating the recording medium with the laser light beam in the scanning direction to form, as the drawing mark, the striped pattern on each of the plurality of heat-sensitive recording layers. The striped pattern extends in the first direction and has the irregular widths. This allows for a high resolution in a second direction orthogonal to an extending direction of the striped pattern. Meanwhile, the resolution is lower in the first direction parallel to the extending direction of the striped pattern than in the second direction. However, in drawing by means of continuous irradiation of the laser light beam, it is possible to perform drawing by means of heat transfer. It is therefore possible to achieve desired image quality with low power, as compared with drawing by means of pulse irradiation with the laser light beam.

In the drawing object according to the first embodiment described above, the recording medium includes a stacked body. A first heat-sensitive recording layer of the plurality of heat-sensitive recording layers included in the stacked body has the striped pattern drawn as the drawing mark resulting from the irradiation with the laser light beam. The striped pattern extends in the first direction and has the irregular widths. In drawing by irradiating the first heat-sensitive recording layer with the laser light beam, it is possible to perform drawing in a striped shape by means of heat transfer. It is therefore possible to achieve desired image quality with low power, as compared with drawing in a dotted shape by means of pulse irradiation with the laser light beam.

In the method of forming a drawing object according to the second embodiment described above, the recording medium includes a stacked body. The method includes irradiating a first heat-sensitive recording layer of the plurality of heat-sensitive recording layers included in the stacked body to form, as the drawing mark, the striped pattern on the first heat-sensitive recording layer. The striped pattern extends in the first direction and has the irregular widths. In drawing by irradiating the first heat-sensitive recording layer with the laser light beam, it is possible to perform drawing in a striped shape by means of heat transfer. It is therefore possible to achieve desired image quality with low power, as compared with drawing in a dotted shape by means of pulse irradiation with the laser light beam.

### BRIEF DESCRIPTION OF DRAWINGS

FIG. 1 is a diagram illustrating an example of a schematic configuration of a drawing system according to an embodiment of the present disclosure.

FIG. 2 is a diagram illustrating an example of a schematic configuration of a drawing section in FIG. 1.

FIG. 3 is a diagram illustrating an example of a cross-sectional configuration of a recording medium in FIG. 2.

FIG. 4 (A) of FIG. 4 is a diagram illustrating an example of a change in laser power over time. (B) of FIG. 4 is a diagram illustrating an example of a drawing mark.

FIG. 5 (A) of FIG. 5 is a diagram illustrating an example of the change in the laser power over time. (B) of FIG. 5 is a diagram illustrating an example of the drawing mark.

FIG. 6 (A) of FIG. 6 is a diagram illustrating an example of the change in the laser power over time. (B) of FIG. 6 is a diagram illustrating an example of the drawing mark.

FIG. 7 is a diagram illustrating an example of a drawing object formed by irradiating the recording medium in FIG. 2 with a laser light beam.

FIG. 8 is a diagram illustrating an example of image data obtained by performing imaging of the drawing object in FIG. 7.

FIG. 9 is a diagram illustrating an example of a spatial frequency spectrum of the image data in FIG. 8.

FIG. 10 (A) of FIG. 10 is a diagram illustrating an example of measurement regions specified in the image data. (B) of FIG. 10 is a diagram illustrating an example of a peak ratio (an intensity ratio at a peak position) in each of the measurement regions.

FIG. 11 is a diagram illustrating a modification example of the schematic configuration of the drawing system according to the embodiment of the present disclosure.

FIG. 12 (A) of FIG. 12 is a diagram illustrating an example of image data of a drawing object formed by irradiating a recording medium with a laser light beam by means of the drawing system in FIG. 11. (B) of FIG. 12 is a diagram illustrating an example of a spatial frequency spectrum of the image data.

FIG. 13 is a diagram illustrating a modification example of the schematic configuration of the drawing system according to the embodiment of the present disclosure.

FIG. 14 is a diagram illustrating a modification example of the schematic configuration of the drawing system according to the embodiment of the present disclosure.

FIG. 15 is a diagram illustrating an example of a perspective configuration of a stacked body including the recording medium in FIG. 3.

FIG. 16 is a diagram illustrating an example of a cross-sectional configuration taken along a line A-A in FIG. 15.

FIG. 17 is a diagram illustrating a modification example of the cross-sectional configuration taken along the line A-A in FIG. 15.

FIG. 18 is a diagram illustrating a modification example of the cross-sectional configuration taken along the line A-A in FIG. 15.

FIG. 19 is a diagram illustrating a modification example of the cross-sectional configuration taken along the line A-A in FIG. 15.

FIG. 20 is a diagram illustrating a modification example of the schematic configuration of the drawing system in FIG. 1.

FIG. 21 is a diagram illustrating an example of a schematic configuration of a drawing section in FIG. 20.

FIG. 22 is a diagram illustrating a modification example of the schematic configuration of the drawing system in FIG. 1.

FIG. 23 is a diagram illustrating an example of a drawing object formed by irradiating the stacked body in FIG. 15 with a laser light beam.

FIG. 24 is a diagram illustrating an example of a schematic configuration of a drawing section in FIG. 22.

FIG. 25 is a diagram illustrating a modification example of the schematic configuration of the drawing section in FIG. 21.

FIG. 26 is a diagram illustrating an example of a drawing method in a drawing system including the drawing section in FIG. 25.

### MODES FOR CARRYING OUT TIE INVENTION

In the following, some embodiments of the present disclosure are described in detail in the following order with reference to the drawings. The following description is specific examples of the present disclosure, and the present disclosure is not limited to the following embodiments. Note that the same or corresponding parts are denoted by the same reference numerals in the following.

### 1. Embodiment

An example in which a recording medium is irradiated continuously with a laser light beam

### 2. Modification Examples

Modification Example A: An example in which a stage is rotated by θ

Modification Example B: An example in which an XY scanner is used

Modification Example C: An example in which a stacked body including the recording medium is irradiated continuously with the laser light beam

Modification Example D: An example in which a laser marking layer is provided in the stacked body

Modification Example E: An example in which respective optical axes of light beams of light sources are shifted from each other

### 1. Embodiment

### [Configuration]

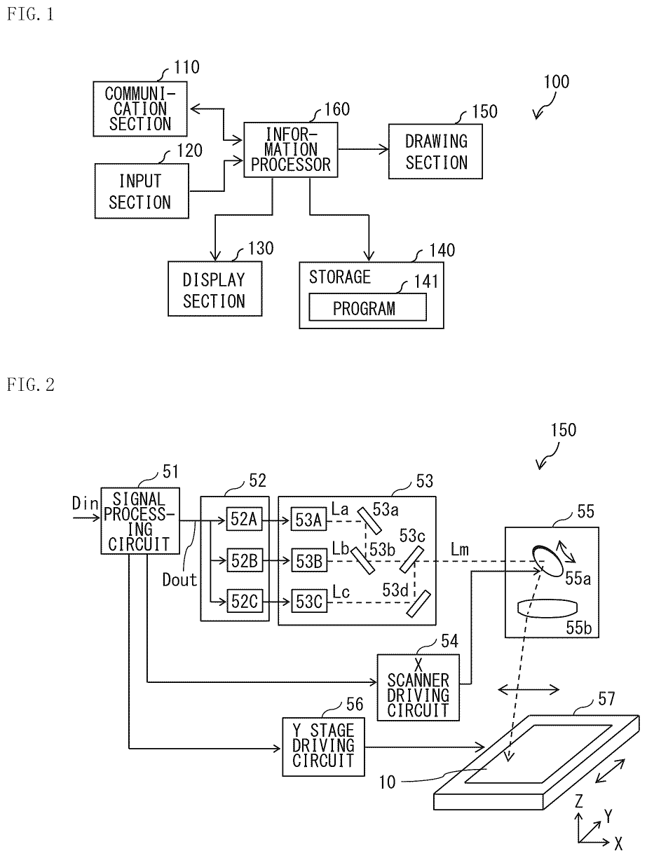

A description is given of a drawing system 100 according to an embodiment of the present disclosure. FIG. 1 illustrates an example of a schematic configuration of the drawing system 100. The drawing system 100 is configured to write (draw) and erase information in a recording medium 10 to be described later. The drawing system 100 is configured to convert, for example, externally inputted image data described in a device-dependent color space (hereinafter, referred to as “input image data”) into image data described in a color space of the recording medium 10 (hereinafter, referred to as “drawing image data”).

Here, the device-dependent color space is an RGB color space such as sRGB or adobe (registered trademark) RGB, for example. The color space of the recording medium 10 is a color space which the recording medium 10 has as characteristics. The drawing system 100 is further configured to convert, for example, the drawing image data obtained by the conversion into output setting values of a drawing section 150 to be described later and input the output setting values obtained by the conversion to the drawing section 150 to thereby perform drawing on the recording medium 10. In the following, first, the drawing system 100 is described, and then the recording medium 10 is described.

### (Drawing System 100)

The drawing system 100 includes, for example, a communication section 110, an input section 120, a display section 130, a storage 140, the drawing section 150, and an information processor 160. The drawing system 100 is coupled to a network via the communication section 110, for example. The network is, for example, a communication line such as a LAN or a WAN. For example, a terminal device is coupled to the network. The drawing system 100 is configured, for example, to communicate with the terminal device via the network. The terminal device is, for example, a mobile terminal, and is configured to communicate with the drawing system 100 via the network.

The communication section 110 is configured to communicate with an external device such as the terminal device. The communication section 110 is configured to transmit, for example, input image data received from the external device such as the mobile terminal, to the information processor 160. The input image data is data in which gradation values of each drawing coordinate are described in the device-dependent color space. In the input image data, the gradation values of each drawing coordinate include, for example, an 8-bit red gradation value, an 8-bit green gradation value, and an 8-bit blue gradation value.

The input section 120 is configured to accept input from a user (e.g., an execution instruction, data input, etc.). The input section 120 is configured to transmit information inputted by the user to the information processor 160. The display section 130 is configured to display a screen on the basis of various pieces of screen data created by the information processor 160. The display section 130 includes, for example, a liquid crystal panel, an organic EL (Electro Luminescence) panel, or the like.

The storage 140 contains, for example, various programs. The storage 140 contains, for example, a program adapted to convert the input image data described in the device-dependent color space into the drawing image data described in the color space of the recording medium 10. The drawing image data is, for example, data in which gradation values of each drawing coordinate are described in the color space of the recording medium 10. In a case where the color space of the recording medium 10 is a leuco color space, the gradation values of each drawing coordinate in the drawing image data include, for example, an 8-bit magenta gradation value, an 8-bit cyan gradation value, and an 8-bit yellow gradation value. The storage 140 contains, for example, a program adapted to derive the output setting values of the drawing section 150 for each drawing coordinate on the basis of the gradation values of the drawing image data obtained by the conversion. In FIG. 1, these programs are collectively represented by a program 141.

The information processor 160 includes, for example, a CPU (Central Processing Unit) and a GPU (Graphics Processing Unit), and executes various programs (e.g., the program 141) stored in the storage 140. The information processor 160 is configured to execute a series of procedures described in the program 141, for example, by loading the program 141.

Next, a description is given of the drawing section 150. FIG. 2 illustrates an example of a schematic configuration of the drawing section 150. The drawing section 150 includes, for example, a signal processing circuit 51, a laser driving circuit 52, a light source section 53, an X scanner driving circuit 54, an X scanner section 55, a Y stage driving circuit 56, and a Y stage 57. The drawing section 150 is configured to execute drawing on the recording medium 10 by controlling output of the light source section 53 on the basis of a voltage value file (a list of command voltage values) inputted from the information processor 160.

The signal processing circuit 51 is configured to acquire the voltage value file (the list of command voltage values) inputted from the information processor 160 as an image signal Din. The signal processing circuit 51 is configured to generate, from the image signal Din, a pixel signal Dout corresponding to a scanner operation of the X scanner section 55, for example. The pixel signal Dout causes the light source section 53 (e.g., each of light sources 53A, 53B, and 53C to be described later) to output a laser light beam having power corresponding to the command voltage values. The signal processing circuit 51 is configured to control, together with the laser driving circuit 52, a peak value of a current to be applied to the light source section 53 (e.g., each of the light sources 53A, 53B, and 53C) depending on the pixel signal Dout.

The laser driving circuit 52 is configured, for example, to drive each of the light sources 53A, 53B, and 53C of the light source section 53 in accordance with the pixel signal Dout. The laser driving circuit 52 is configured, for example, to control luminance (brightness) of a laser light beam to draw an image corresponding to the pixel signal Dout. The laser driving circuit 52 includes, for example, a driving circuit 52A that drives the light source 53A, a driving circuit 52B that drives the light source 53B, and a driving circuit 52C that drives the light source 53C. The light sources 53A, 53B, and 53C are each configured to output a laser light beam having power corresponding to the command voltage values to the recording medium 10 to thereby execute drawing on the recording medium 10. The light sources 53A, 53B, and 53C are each configured to emit a laser light beam in a near-infrared region. The light source 53A is, for example, a semiconductor laser that emits a laser light beam La having a light emission wavelength λ1. The light source 53B is, for example, a semiconductor laser that emits a laser light beam Lb having a light emission wavelength λ2. The light source 53C is, for example, a semiconductor laser that emits a laser light beam Lc having a light emission wavelength λ3.

The light source section 53 includes a plurality of light sources (e.g., the three light sources 53A, 53B, and 53C) different from each other in light emission wavelength in the near-infrared region. Each of the light sources (e.g., each of the light sources 53A, 53B, and 53C) is configured to generate a laser light beam including a wavelength corresponding to a light absorption wavelength band of a photothermal conversion agent (to be described later) included in the recording medium 10. The light source section 53 further includes, for example, an optical system that combines the plurality of laser light beams (e.g., the three laser light beams La, Lb, and Lc) emitted from the plurality of light sources (e.g., the three light sources 53A, 53B, and 53C). Here, “combining” refers to scanning with a plurality of laser light beams performed by one galvano scanner. This optical system is configured, for example, to so output a combined light beam (a laser light beam Lm) of the plurality of laser light beams La, Lb, and Lc to the X scanner section 55 that a plurality of irradiation spots Pa, Pb, and Pc generated on the recording medium 10 by the plurality of laser light beams La, Lb, and Lc overlaps with each other on the Y stage 57. An X-axis direction is a direction orthogonal to a movement direction (a Y-axis direction) of the Y stage 57, and is a direction parallel to a scanning direction of a one-axis scanner 55a to be described later. The light source section 53 includes, for example, two reflection mirrors 53a and 53d, and two dichroic mirrors 53b and 53c as such an optical system.

Each of the laser light beams La and Lb emitted from the two light sources 53A and 53B is converted into substantially parallel light (collimated light) by a collimating lens, for example. Thereafter, for example, the laser light beam La is reflected by the reflection mirror 53a and further reflected by the dichroic mirror 53b, and the laser light beam Lb is transmitted through the dichroic mirror 53b. Thus, the laser light beam La and the laser light beam Lb are combined. The combined light beam of the laser light beam La and the laser light beam La is transmitted through the dichroic mirror 53c.

The laser light beam Lc emitted from the light source 53C is converted into substantially parallel light (collimated light) by a collimating lens. Thereafter, for example, the laser light beam Lc is reflected by the reflection mirror 53d and further reflected by the dichroic mirror 53c. Thus, the above-described combined light beam transmitted through the dichroic mirror 53c and the laser light beam Lc reflected by the dichroic mirror 53c are combined. The light source section 53 is configured, for example, to output, to the X scanner section 55, the above-described light (the laser light beam Lm) obtained by combining by the optical system.

The X scanner driving circuit 54 is configured, for example, to drive the X scanner section 55 on the basis of a control signal inputted from the signal processing circuit 51. In addition, the X scanner driving circuit 54 is configured, for example, to drive, in a case where a signal regarding an irradiation angle of the one-axis scanner 55a to be described later or the like is inputted from the X scanner section 55, the X scanner section 55 to cause the irradiation angle to be a desired irradiation angle on the basis of the inputted signal.

The X scanner section 55 is configured, for example, to scan a surface of the recording medium 10 in the X-axis direction with the laser light beam Lm incident from the light source section 53. The X scanner section 55 includes, for example, the one-axis scanner 55a and an fθ lens 55b. The one-axis scanner 55a is, for example, a galvanometer mirror that scans the surface of the recording medium 10 in the X-axis direction with the laser light beam Lm incident from the light source section 53, on the basis of a drive signal inputted from the X scanner driving circuit 54. The fθ lens 55b is configured to convert a constant speed rotational motion by the one-axis scanner 55a into a constant speed linear motion of a spot moving on a focal plane (the surface of the recording medium 10).

The Y stage driving circuit 56 is configured, for example, to drive the Y stage 57 on the basis of a control signal inputted from the signal processing circuit 51. The Y stage 57 is configured to move the recording medium 10 placed on the Y stage 57 with respect to the X scanner section 55 at a predetermined speed in the Y-axis direction by displacing the Y stage 57 at a predetermined speed in the Y-axis direction. The surface of the recording medium 10 is raster-scanned with the laser light beam Lm by a cooperative operation of the X scanner section 55 and the Y stage 57.

### (Recording Medium 10)

Next, a description is given of the recording medium 10.

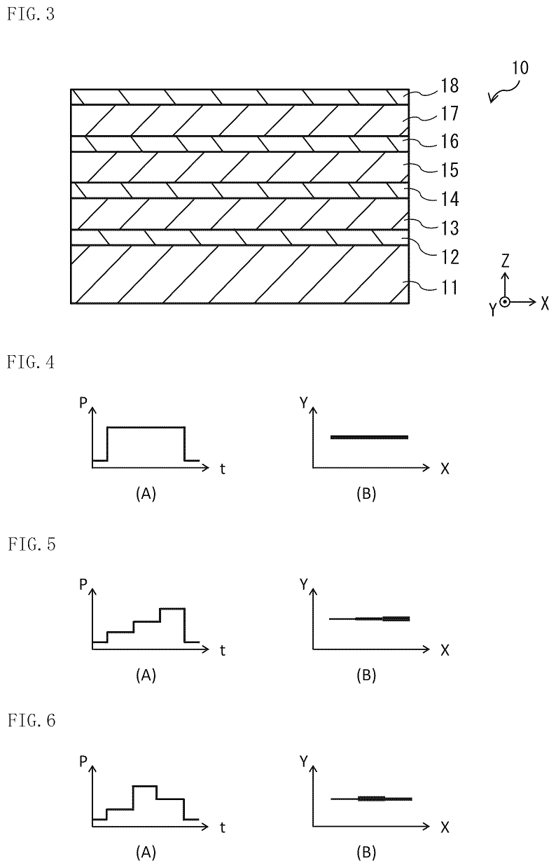

FIG. 3 illustrates an example of a configuration of each layer included in the recording medium 10. The recording medium 10 is a reversible recording medium on which writing (drawing) and erasing of information are possible. The recording medium 10 is a sheet-shaped or plate-shaped recording medium having a quadrangular shape in plan view. In the recording medium 10, an X direction is a direction parallel to one end side of the recording medium 10, and a Y direction is a direction parallel to another end side orthogonal to the foregoing end side of the recording medium 10. The recording medium 10 includes a plurality of recording layers 13, 15, and 17 different from each other in developed color tone. The recording layers 13, 15, and 17 each correspond to one specific example of a “first heat-sensitive recording layer” according to one embodiment of the present disclosure. The recording medium 10 includes, for example, a structure (a stacked body) in which a base layer 12, the recording layer 13, a heat-insulating layer 14, the recording layer 15, a heat-insulating layer 16, the recording layer 17, and a protective layer 18 are stacked in this order on a base material 11. The protective layer 18 is disposed at a position opposed to the base material 11 with the base layer 12, the recording layer 13, the heat-insulating layer 14, the recording layer 15, the heat-insulating layer 16, and the recording layer 17 interposed therebetween. The protective layer 18 may be disposed at an outermost surface of the recording medium 10, or a layer other than the protective layer 18 may be disposed at the outermost surface of the recording medium 10.

The three recording layers 13, 15, and 17 are disposed in order of the recording layer 13, the recording layer 15, and the recording layer 17 from side of the base material 11. The two heat-insulating layers 14 and 16 are disposed in order of the heat-insulating layer 14 and the heat-insulating layer 16 from the side of the base material 11. The base layer 12 is formed in contact with a surface of the base material 11. The protective layer 18 is formed at the outermost surface of the recording medium 10.

The base material 11 supports each of the recording layers 13, 15, and 17 and each of the heat-insulating layers 14 and 16. The base material 11 functions as a substrate having a surface on which each of the layers is to be formed. The base material 11 may allow or may not allow light to be transmitted therethrough. In a case where light is not transmitted, a color of the surface of the base material 11 may be, for example, white or a color other than white.

The base material 11 may be a card or a film. The base material 11 may have one main surface, on side where the recording layer 13 and the like are provided, on which a figure, a picture, a photograph, a character, a combination of two or more of them, or the like is printed.

The base material 11 may be, for example, a highly rigid substrate such as a wafer, or may be, for example, a flexible thin-layer glass, a flexible film, or flexible paper. Using a flexible substrate as the base material 11 makes it possible to achieve the recording medium 10 that is flexible (bendable). Examples of a material included in the base material 11 include an inorganic material, a metal material, plastic, and the like. The inorganic material includes, for example, at least one kind selected from a group including silicon (Si), silicon oxide (SiOₓ), silicon nitride (SiNₓ), aluminum oxide (AlOₓ), and the like. Silicon oxide includes glass, spin-on-glass (SOG), and the like. The metal material includes, for example, at least one kind selected from a group including aluminum (Al), nickel (Ni), stainless steel, and the like.

The base material 11 may include, for example, plastic. The base material 11 may include at least one kind selected from a group including a colorant, an antistatic agent, a flame retardant, a surface modifier, and the like, as necessary.

The plastic included in the base material 11 includes, for example, at least one kind selected from a group including an ester-based resin, an amide-based resin, an olefin-based resin, a vinyl-based resin, an acrylic-based resin, an imide-based resin, a styrene-based resin, engineering plastic, and the like. In a case where the base material 11 includes two or more kinds of the resins, the two or more kinds of the resins may be mixed, copolymerized, or stacked.

The ester-based resin described above includes, for example, at least one kind selected from a group including polyethylene terephthalate (PET), polybutylene terephthalate (PBT), polyethylene naphthalate (PEN), a polyethylene terephthalate-isophthalate copolymer, a terephthalic acid-cyclohexane dimethanol-ethylene glycol copolymer, and the like. The amide-based resin described above includes, for example, at least one kind selected from a group including nylon 6, nylon 66, nylon 610, and the like. The olefin-based resin described above includes, for example, at least one kind selected from a group including polyethylene (PE), polypropylene (PP), polymethylpentene (PMP), and the like. The vinyl-based resin described above includes, for example, polyvinyl chloride (PVC).

The acrylic-based resin described above includes, for example, at least one kind selected from a group including polyacrylate, polymethacrylate, polymethyl methacrylate (PMMA), and the like. The imide-based resin described above includes, for example, at least one kind selected from a group including polyimide (PI), polyamideimide (PAI), polyetherimide (PEI), and the like. The styrene-based resin described above includes, for example, at least one kind selected from a group including polystyrene (PS), high-impact polystyrene, an acrylonitrile-styrene resin (an AS resin), an acrylonitrile-butadiene-styrene resin (an ABS resin), and the like. The engineering plastic described above includes, for example, at least one kind selected from a group including polycarbonate (PC), polyarylate (PAR), polysulfone (PSF), polyethersulfone (PES), polyphenylene ether (PPE), polyphenylene sulfide (PPS), polyetherketone (PEK), polyetheretherketone (PEEK), polyphenylene oxide (PPO), polyether sulfite, and the like.

The base layer 12 has a function of improving adherence between the recording layer 13 and the base material 11. The base layer 12 includes, for example, a material that allows light to be transmitted therethrough. It is to be noted that a moisture-resistant barrier layer, a light-resistant barrier layer, or the like may be provided above or below the base layer 12 or the base material 11. In addition, a heat-insulating layer may be provided between the base layer 12 and the recording layer 13.

The three recording layers 13, 15, and 17 are each reversibly changeable in state between a color-developed state and a decolored state. The three recording layers 13, 15, and 17 are so configured that the colors in the color-developed states are different from each other. Each of the three recording layers 13, 15, and 17 is a heat-sensitive recording layer that includes a coloring compound, a photothermal conversion agent, and a color developing/reducing agent. The three recording layers 13, 15, and 17 include respective coloring compounds that are different from each other in color in the color-developed state, and include respective photothermal conversion agents that are different from each other in light absorption wavelength band. In each of the three recording layers 13, 15, and 17, the coloring compound, the photothermal conversion agent, and the color developing/reducing agent are dispersed in a matrix resin (a polymer material). Each of the three recording layers 13, 15, and 17 may be a stacked body in which a layer including the coloring compound and the color developing/reducing agent and a layer including the photothermal conversion agent are stacked, or may have a single-layer structure including the coloring compound, the photothermal conversion agent, and the color developing/reducing agent.

As the coloring compound, for example, a leuco dye is used. The leuco dye is combined with the color developing/reducing agent by heat to turn into the color-developed state or is separated from the color developing/reducing agent to turn into the decolored state. Developed color tones of the leuco dyes included in the respective recording layers 13, 15, and 17 are different among the recording layers 13, 15, and 17. The leuco dye included in the recording layer 13 is combined with the color developing/reducing agent by heat to develop a magenta color. The leuco dye included in the recording layer 15 is combined with the color developing/reducing agent by heat to develop a cyan color. The leuco dye included in the recording layer 17 is combined with the color developing/reducing agent by heat to develop a yellow color. The positional relationship among the three recording layers 13, 15, and 17 is not limited to the example described above. In addition, the three recording layers 13, 15, and 17 are transparent in the decolored state. The recording medium 10 is thus configured to record an image using colors of a wide color gamut.

The photothermal conversion agent absorbs light in a predetermined wavelength region of the near-infrared region and generates heat, for example. It is to be noted that in this specification, the near-infrared region refers to a wavelength band of 700 nm to 2500 nm. It is preferable to select photothermal conversion agents having light absorption bands that are narrow in the near-infrared region and do not overlap with each other among the recording layers 13, 15, and 17.

The heat-insulating layer 14 helps to prevent heat from being transferred easily between the recording layer 13 and the recording layer 15. The heat-insulating layer 16 helps to prevent heat from being transferred easily between the recording layer 15 and the recording layer 17.

The heat-insulating layers 14 and 16 include, for example, a matrix resin (a polymer compound) having a typical light transmission property. A specific material includes, for example, at least one kind selected from a group including an acrylic-based resin, a polyvinyl-chloride-based resin, a polyvinyl-acetate-based resin, a vinyl-chloride-vinyl-acetate-copolymer-based resin, an ethyl-cellulose-based resin, a polystyrene-based resin, a styrene-based-copolymer-based resin, a phenoxy-resin-based resin, a polyester-based resin, an aromatic-polyester-based resin, a polyurethane-based resin, a polycarbonate-based resin, a polyacrylic-acid-ester-based resin, a polymethacrylic-acid-ester-based resin, an acrylic-acid-based-copolymer-based resin, a maleic-acid-based-polymer-based resin, a polyvinyl-alcohol-based resin, a modified-polyvinyl-alcohol-based resin, a hydroxyethyl-cellulose-based resin, a carboxymethyl-cellulose-based resin, starch, and the like. The heat-insulating layers 14 and 16 may include, for example, any of various kinds of additives including, without limitation, an ultraviolet absorber.

The heat-insulating layers 14 and 16 may each be, for example, an ultraviolet curable resin layer. The ultraviolet curable resin layer includes an ultraviolet curable resin composition that has been undergone a polymerization reaction to be a solid. More specifically, for example, the ultraviolet curable resin layer includes a polymer of a polymerizable compound and a polymerization initiator in which active species are generated and the structure is changed as a result of irradiation with external energy (ultraviolet rays). The ultraviolet curable resin composition includes, for example, at least one kind selected from a group including a radical polymerization-type ultraviolet curable resin composition, a cation polymerization-type ultraviolet curable resin composition, and the like. The ultraviolet curable resin composition may include at least one kind selected from a group including a sensitizer, a filler, a stabilizer, a leveling agent, an antifoamer, a viscosity modifier, and the like, as necessary. The ultraviolet curable resin composition may be a hard coating ultraviolet curable resin composition. The ultraviolet curable resin composition may be an acrylic-based ultraviolet curable resin composition.

The heat-insulating layers 14 and 16 may each include an inorganic material having a light transmission property. For example, the use of porous silica, porous alumina, porous titania, porous carbon, a composite thereof, or the like decreases a heat transfer rate to increase a heat-insulating effect, which is preferable. The heat-insulating layers 14 and 16 may be formed by, for example, a sol-gel method.

A thickness of each of the heat-insulating layers 14 and 16 is preferably 3 μm or greater and 100 μm or less, and more preferably 5 μm or greater and 50 μm or less. When the thickness of each of the heat-insulating layers 14 and 16 is 3 μm or greater, it is possible to achieve a sufficient heat-insulating effect. Meanwhile, when the thickness of each of the heat-insulating layers 14 and 16 is 100 μm or less, it is possible to suppress a decrease in light transmission property. In addition, it is possible to suppress a decrease in bending tolerance of the recording medium 10 and to prevent a defect such as a crack from occurring easily.

A pencil hardness of a surface of each of the heat-insulating layers 14 and 16 is preferably 2B or higher, and more preferably H or higher. When the pencil hardness of the surface of each of the heat-insulating layers 14 and 16 is 2B or higher, the heat-insulating layers 14 and 16 obtain a high compactness, which makes it possible to further suppress diffusion of a material via the heat-insulating layers 14 and 16. For example, in a case where the pencil hardness of the surface of each of the heat-insulating layers 14 and 16 is 2B or higher, it is possible to further suppress diffusion of the coloring compound via the heat-insulating layers 14 and 16. Accordingly, it is possible to further suppress hue change in the recording layers 13, 15, and 17 due to long-period storage or the like. As each of the heat-insulating layers 14 and 16 having the above-described pencil hardness, an ultraviolet curable resin layer is preferable.

The pencil hardness of the surface of the heat-insulating layer 14 is measured as described below. First, the recording medium 10 is disassembled to expose the surface of the heat-insulating layer 14. Thereafter, the pencil hardness of the surface of the heat-insulating layer 14 is measured in accordance with JISK5600-5-4. The measurement is performed in an atmosphere in a standard state at a temperature of 23±1° C. and at a relative humidity of 50±5% The pencil hardness of the surface of the heat-insulating layer 16 is also measured by a procedure similar to that for the pencil hardness of the surface of the heat-insulating layer 14.

The protective layer 18 is adapted to protect the surface of the recording medium 10 and functions as an overcoat layer of the recording medium 10. The heat-insulating layers 14 and 16 and the protective layer 18 each include a transparent material. The recording medium 10 may include, for example, a resin layer with relatively high rigidity (e.g., a PEN resin layer) immediately below the protective layer 18. It is to be noted that the protective layer 18 may include a moisture-resistant barrier layer or a light-resistant barrier layer. In addition, the protective layer 18 may include any functional layer. The protective layer 18 includes, for example, at least one kind of an ultraviolet-curable resin or a thermosetting resin. The protective layer 18 is preferably a hard coat layer. The protective layer 18 has, for example, a thickness of 0.1 μm or greater and 20 μm or less.

In the recording medium 10, an adhesive layer may be provided between two layers adjacent to each other. The adhesive layer adheres the two adjacent layers to each other. The adhesive layer may have the function of the heat-insulating layers 14 and 16. The adhesive layer includes an adhesive. The adhesive includes, for example, at least one kind selected from a group including an acrylic-based resin, a silicone-based resin, a urethane-based resin, an epoxy-based resin, and an elastomer-based resin.

Examples of the leuco dye include existing dyes for thermal paper. One specific example thereof is a compound including, for example, a group having an electron donating property in a molecule. The compound is represented by the following Chem. 1.

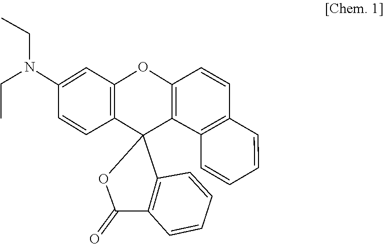 [SMILES: CCN(CC)c1ccc2c(c1)Oc1ccc3ccccc3c1C21OC(=O)c2ccccc21]

The coloring compound is not specifically limited, and may be appropriately selected depending on purposes. In addition to the compound represented by Chem. 1 described above, examples of a specific coloring compound include a fluoran-based compound, a triphenylmethane phthalide-based compound, an azaphthalide-based compound, a phenothiazine-based compound, a leuco auramine-based compound, an indolinophthalide-based compound, and the like. In addition to these materials, the examples include 2-anilino-3-methyl-6-diethylaminofluoran, 2-anilino-3-methyl-6-di(n-butylamino)fluoran, 2-anilino-3-methyl-6-(N-n-propyl-N-methylamino)fluoran, 2-anilino-3-methyl-6-(N-isopropyl-N-methylamino)fluoran, 2-anilino-3-methyl-6-(N-isobutyl-N-methylamino)fluoran, 2-anilino-3-methyl-6-(N-n-amyl-N-methylamino)fluoran, 2-anilino-3-methyl-6-(N-sec-butyl-N-methylamino)fluoran, 2-anilino-3-methyl-6-(N-n-amyl-N-ethylamino)fluoran, 2-anilino-3-methyl-6-(N-iso-amyl-N-ethylamino)fluoran, 2-anilino-3-methyl-6-(N-n-propyl-N-isopropylamino)fluoran, 2-anilino-3-methyl-6-(N-cyclohexyl-N-methylamino)fluoran, 2-anilino-3-methyl-6-(N-ethyl-p-toluidino)fluoran, 2-anilino-3-methyl-6-(N-methyl-p-toluidino)fluoran, 2-(m-trichloromethylanilino)-3-methyl-6-diethylaminofluoran, 2-(m-trifluloromethylanilino)-3-methyl-6-diethylaminofluoran, 2-(m-trichloromethylanilino)-3-methyl-6-(N-cyclohexyl-N-methylamino)fluoran, 2-(2,4-dimethylanilino)-3-methyl-6-diethylaminofluoran, 2-(N-ethyl-p-toluidino)-3-methyl-6-(N-ethylanilino)fluoran, 2-(N-ethyl-p-toluidino)-3-methyl-6-(N-propyl-p-toluidino)fluoran, 2-anilino-6-(N-n-hexyl-N-ethylamino)fluoran, 2-(o-chloroanilino)-6-diethylaminofluoran, 2-(o-chloroanilino)-6-dibutylaminofluoran, 2-(m-trifluoromethylanilino)-6-diethylaminofluoran, 2,3-dimethyl-6-dimethylaminofluoran, 3-methyl-6-(N-ethyl-p-toluidino)fluoran, 2-chloro-6-diethylaminofluoran, 2-bromo-6-diethylaminofluoran, 2-chloro-6-dipropylaminofluoran, 3-chloro-6-cyclohexylaminofluoran, 3-bromo-6-cyclohexylaminofluoran, 2-chloro-6-(N-ethyl-N-isoamylamino)fluoran, 2-chloro-3-methyl-6-diethylaminofluoran, 2-anilino-3-chloro-6-diethylaminofluoran, 2-(o-chloroanilino)-3-chloro-6-cyclohexylaminofluoran, 2-(m-trifluoromethylanilino)-3-chloro-6-diethylaminofluoran, 2-(2,3-dichloroanilino)-3-chloro-6-diethylaminofluoran, 1,2-benzo-6-diethylaminofluoran, 3-diethylamino-6-(m-trifluoromethylanilino)fluoran, 3-(1-ethyl-2-methylindole-3-yl)-3-(2-ethoxy-4-diethylaminophenyl)-4-azaphthalide, 3-(1-ethyl-2-methylindole-3-yl)-3-(2-ethoxy-4-diethylaminophenyl)-7-azaphthalide, 3-(1-octyl-2-methylindole-3-yl)-3-(2-ethoxy-4-diethylaminophenyl)-4-azaphthalide, 3-(1-ethyl-2-methylindole-3-yl)-3-(2-methyl-4-diethylaminophenyl)-4-azaphthalide, 3-(1-ethyl-2-methylindole-3-yl)-3-(2-methyl-4-diethylaminophenyl)-7-azaphthalide, 3-(1-ethyl-2-methylindole-3-yl)-3-(4-diethylaminophenyl)-4-azaphthalide, 3-(1-ethyl-2-methylindole-3-yl)-3-(4-N-n-amyl-N-methylaminophenyl)-4-azaphthalide, 3-(1-methyl-2-methylindole-3-yl)-3-(2-hexyloxy-4-diethylaminophenyl)-4-azaphthalide, 3,3-bis(2-ethoxy-4-diethylaminophenyl)-4-azaphthalide, 3,3-bis(2-ethoxy-4-diethylaminophenyl)-7-azaphthalide, 2-(p-acetylanilino)-6-(N-n-amyl-N-n-butylamino)fluoran, 2-benzylamino-6-(N-ethyl-p-toluidino)fluoran, 2-benzylamino-6-(N-methyl-2,4-dimethylanilino)fluoran, 2-benzylamino-6-(N-ethyl-2,4-dimethylanilino)fluoran, 2-benzylamino-6-(N-methyl-p-toluidino)fluoran, 2-benzylamino-6-(N-ethyl-p-toluidino)fluoran, 2-(di-p-methylbenzylamino)-6-(N-ethyl-p-toluidino)fluoran, 2-(α-phenylethylamino)-6-(N-ethyl-p-toluidino)fluoran, 2-methylamino-6-(N-methylanilino)fluoran, 2-methylamino-6-(N-ethylanilino)fluoran, 2-methylamino-6-(N-propylanilino)fluoran, 2-ethylamino-6-(N-methyl-p-toluidino)fluoran, 2-methylamino-6-(N-methyl-2,4-dimethylanilino)fluoran, 2-ethylamino-6-(N-ethyl-2,4-dimethylanilino)fluoran, 2-dimethylamino-6-(N-methylanilino)fluoran, 2-dimethylamino-6-(N-ethylanilino)fluoran, 2-diethylamino-6-(N-methyl-p-toluidino)fluoran, 2-diethylamino-6-(N-ethyl-p-toluidino)fluoran, 2-dipropylamino-6-(N-methylanilino)fluoran, 2-dipropylamino-6-(N-ethylanilino)fluoran, 2-amino-6-(N-methylanilino)fluoran, 2-amino-6-(N-ethylanilino)fluoran, 2-amino-6-(N-propylanilino)fluoran, 2-amino-6-(N-methyl-p-toluidino)fluoran, 2-amino-6-(N-ethyl-p-toluidino)fluoran, 2-amino-6-(N-propyl-p-toluidino)fluoran, 2-amino-6-(N-methyl-p-ethylanilino)fluoran, 2-amino-6-(N-ethyl-p-ethylanilino)fluoran, 2-amino-6-(N-propyl-p-ethylanilino)fluoran, 2-amino-6-(N-methyl-2,4-dimethylanilino)fluoran, 2-amino-6-(N-ethyl-2,4-dimethylanilino)fluoran, 2-amino-6-(N-propyl-2,4-dimethylanilino)fluoran, 2-amino-6-(N-methyl-p-chloroanilino)fluoran, 2-amino-6-(N-ethyl-p-chloroanilino)fluoran, 2-amino-6-(N-propyl-p-chloroanilino)fluoran, 1,2-benzo-6-(N-ethyl-N-isoamylamino)fluoran, 1,2-benzo-6-dibutylaminofluoran, 1,2-benzo-6-(N-methyl-N-cyclohexylamino)fluoran, 1,2-benzo-6-(N-ethyl-N-toluidino)fluoran, and the like. For each of the recording layers 13, 15, and 17, as the coloring compound, one kind of the compounds described above may be used alone, or two or more kinds of the compounds described above may be used in combination.

The color developing/reducing agent is adapted to develop a color of a colorless coloring compound or decolor a coloring compound colored in a predetermined color. Examples of the color developing/reducing agent include a phenol derivative, a salicylic acid derivative, a urea derivative, and the like. Specifically, the color developing/reducing agent may include, for example, a compound represented by the following Chem. 2.

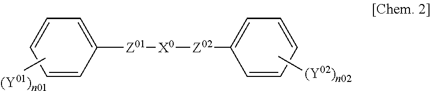

(where in a formula (3): X⁰ represents a bivalent group including at least one benzene ring; in a case where X⁰ includes at least two benzene rings, the at least two benzene rings may be condensed; an example thereof may be naphthalene, anthracene, or the like; Y⁰¹ and Y⁰² each independently represent a univalent group; n01 and n02 each independently represent an integer of any one of 0 to 5; in a case where n01 represents an integer of any one of 2 to 5, Y⁰¹s may be the same as or different from each other; in a case where n02 represents an integer of any one of 2 to 5, Y⁰²s may be the same as or different from each other; and Z⁰¹ and Z⁰² each independently represent a hydrogen-bonding group.)

The color developing agent may include, for example, a compound represented by the following Chem. 3.

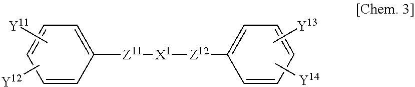

(where in Chem. 3: X¹ represents a bivalent group including at least one benzene ring; Y¹, Y¹², Y¹³, and Y¹⁴ each independently represent a univalent group; and Z¹¹ and Z¹² each independently represent a hydrogen-bonding group.)

In a case where Chem. 2 and Chem. 3 each include a hydrocarbon group, the hydrocarbon group is a generic term for a group including carbon (C) and hydrogen (H), and may be a saturated hydrocarbon group or an unsaturated hydrocarbon group. The saturated hydrocarbon group is an aliphatic hydrocarbon group having no carbon-carbon multiple bond, and the unsaturated hydrocarbon group is an aliphatic hydrocarbon group having a carbon-carbon multiple bond (a carbon-carbon double bond or a carbon-carbon triple bond).

In the case where Chem. 2 and Chem. 3 each include a hydrocarbon group, the hydrocarbon group may have a chain structure, or may include one, or two or more rings. The chain structure may be a straight-chain structure, or a branched structure including one, or two or more side chains or the like.

(X⁰ and X¹ Each Including One Benzene Ring)

Each of X⁰ in Chem. 2 and X¹ in Chem. 3 represents, for example, a bivalent group including one benzene ring. The bivalent group is represented by the following Chem. 4, for example.

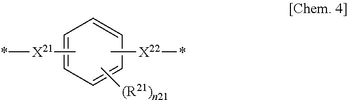

(where in Chem. 4: presence of X²¹ is optional; in a case where X²¹ is present, X²¹ represents a bivalent group; presence of X²² is optional; in a case where X²² is present, X²² represents a bivalent group; R²¹ represents a univalent group; n21 represents an integer of any one of 0 to 4; in a case where n21 represents an integer of any one of 2 to 4, R²¹s may be the same as or different from each other; and a* mark represents a bond part.)

In Chem. 4, binding positions of X²¹ and X²² to the benzene ring are not limited. In other words, the binding positions of X²¹ and X²² to the benzene ring may be any one of an ortho position, a meta position, or a para position.

It is preferable that the bivalent group including one benzene ring described above be represented by the following Chem. 5 in terms of improvement in high-temperature high-humidity storage characteristics.

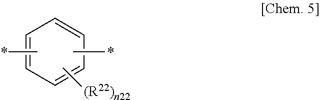

(where in Chem. 5: R²² represents a univalent group; n22 represents an integer of any one of 0 to 4; in a case where n22 represents an integer of any one of 2 to 4, R²²s may be the same as or different from each other; and a* mark represents a bond part.)

In a case where X⁰ in Chem. 2 represents a bivalent group including one benzene ring, in Chem. 5, binding positions of Z⁰¹ and Z⁰² to the benzene ring are not limited. In other words, the binding positions of Z⁰¹ and Z⁰² to the benzene ring may be any one of an ortho position, a meta position, or a para position.

In a case where X¹ in Chem. 3 represents a bivalent group including one benzene ring, in Chem. 5, binding positions of Z¹¹ and Z¹² to the benzene ring are not limited. In other words, the binding positions of Z¹¹ and Z¹² to the benzene ring may be any one of an ortho position, a meta position, or a para position.

(X²¹ and X²²)

It is sufficient that X²¹ and X²² in Chem. 4 each independently represent a bivalent group. Each of X²¹ and X²² is not particularly limited, and one example thereof is a hydrocarbon group that optionally includes a substituent group. The hydrocarbon group preferably has a chain structure, and is specifically preferably a normal alkyl chain.

Carbon number of the hydrocarbon group that optionally includes a substituent group is, for example, 1 or greater and 15 or less, 1 or greater and 13 or less, 1 or greater and 12 or less, 1 or greater and 10 or less, 1 or greater and 6 or less, or 1 or greater and 3 or less.

In a case where each of X²¹ and X²² in Chem. 4 represents a normal alkyl group, carbon number of the normal alkyl group is preferably 8 or less, more preferably 6 or less, still more preferably 5 or less, and specifically preferably 3 or less in terms of high-temperature storage stability. When the carbon number of the normal alkyl group is 8 or less, the length of the normal alkyl group is short. Conceivably, this helps to prevent thermal disturbance from occurring easily in the color developing agent during high-temperature storage, and helps to prevent a part interacting with the coloring compound such as the leuco dye from being separated easily during color development. This helps to prevent the coloring compound such as the leuco dye from being decolored easily during high-temperature storage, which improves high-temperature storage stability.

Examples of a substituent group that optionally includes a hydrocarbon group include a halogen group (e.g., a fluorine group), an alkyl group including a halogen group (e.g., a fluorine group), and the like. The hydrocarbon group that optionally includes a substituent group may be a hydrocarbon group in which a part of carbon of the hydrocarbon group (e.g., a part of carbon included in a main chain of the hydrocarbon group) is substituted by an element such as oxygen.

### (R²¹)

It is sufficient that R²¹ in Chem. 4 represents a univalent group. R²¹ is not particularly limited, and one example thereof is a halogen group or a hydrocarbon group that optionally includes a substituent group.

The halogen group is, for example, a fluorine group (—F), a chlorine group (—Cl), a bromine group (—Br), or an iodine group (—I).

Carbon number of the hydrocarbon group that optionally includes a substituent group is, for example, 1 or greater and 15 or less, 1 or greater and 13 or less, 1 or greater and 12 or less, 1 or greater and 10 or less, 1 or greater and 6 or less, or 1 or greater and 3 or less.

Examples of a substituent group that optionally includes a hydrocarbon group include a halogen group (e.g., a fluorine group), an alkyl group including a halogen group (e.g., a fluorine group), and the like. The hydrocarbon group that optionally includes a substituent group may be a hydrocarbon group in which a part of carbon of the hydrocarbon group (e.g., a part of carbon included in a main chain of the hydrocarbon group) is substituted by an element such as oxygen.

### (R²²)

It is sufficient that R²² in Chem. 5 represents a univalent group. R²² is not specifically limited, and one example thereof is a halogen group or a hydrocarbon group that optionally includes a substituent group. The halogen group and the hydrocarbon group that optionally includes a substituent group are each similar to that of R²¹ in Chem. 2.

(X⁰ and X¹ Each Including Two Benzene Rings)

Each of X⁰ in Chem. 2 and X¹ in Chem. 3 represents, for example, a bivalent group including two benzene rings. The bivalent group is represented by the following Chem. 6, for example.

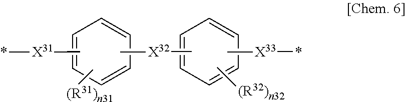

(where in Chem. 6: presence of X³¹ is optional; in a case where X³¹ is present, X³¹ represents a bivalent group; presence of X³² is optional; in a case where X³² is present, X³² represents a bivalent group; presence of X³³ is optional; in a case where X³³ is present, X³³ represents a bivalent group; R³¹ and R³² each independently represent a univalent group; n31 and n32 each independently represent an integer of any one of 0 to 4; in a case where n31 represents an integer of any one of 2 to 4, R³¹s may be the same as or different from each other; in a case where n32 represents an integer of any one of 2 to 4, R³²s may be the same as or different from each other; and a* mark represents a bond part.)

In Chem. 6, binding positions of X³¹ and X³² to the benzene ring are not limited. In other words, the binding positions of X³¹ and X³² to the benzene ring may be any one of an ortho position, a meta position, or a para position. Similarly, in Chem. 6, binding positions of X³² and X³³ to the benzene ring are not limited. In other words, the binding positions of X³² and X³³ to the benzene ring may be any one of an ortho position, a meta position, or a para position.

The bivalent group including two benzene rings described above is preferably represented by the following Chem. 7 in terms of improvement in high-temperature high-humidity storage characteristics.

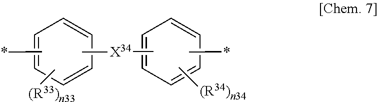

(where in Chem. 7: X³⁴ represents a bivalent group; R³³ and R³⁴ each independently represent a univalent group; n33 and n34 each independently represent an integer of any one of 0 to 4; in a case where n33 represents an integer of any one of 2 to 4, R³³s may be the same as or different from each other; in a case where n34 represents an integer of any of 2 to 4, R³⁴s may be the same as or different from each other; and a* mark represents a bond part.)

In a case where X⁰ in Chem. 2 represents a bivalent group including two benzene rings, in Chem. 7, binding positions of Z⁰¹ and X³⁴ to the benzene ring are not limited. In other words, the binding positions of Z⁰¹ and X³⁴ to the benzene ring may be any one of an ortho position, a meta position, or a para position. Similarly, in Chem. 7, binding positions of Z⁰² and X³⁴ to the benzene ring are not limited. In other words, the binding positions of Z⁰² and X³⁴ to the benzene ring may be any one of an ortho position, a meta position, or a para position.

In a case where X¹ in Chem. 3 represents a bivalent group including two benzene rings, in Chem. 7, binding positions of Z¹¹ and X³⁴ to the benzene ring are not limited. In other words, the binding positions of Z¹¹ and X³⁴ to the benzene ring may be any one of an ortho position, a meta position, or a para position. Similarly, in Chem. 7, binding positions of Z¹² and X³⁴ to the benzene ring are not limited. In other words, the binding positions of Z¹² and X³⁴ to the benzene ring may be any one of an ortho position, a meta position, or a para position.

(X³¹, X³², and X³³)

It is sufficient that X³¹, X³², and X³³ in Chem. 6 each independently represent a bivalent group. Each of X³¹, X³², and X³³ is not particularly limited, and one example thereof is a hydrocarbon group that optionally includes a substituent group. The hydrocarbon group is similar to that of each of X²¹ and X²² in Chem. 4 described above.

### (X³⁴)

It is sufficient that X³⁴ in Chem. 7 represents a bivalent group. X³⁴ is not specifically limited, and one example thereof is a hydrocarbon group that optionally includes a substituent group. The hydrocarbon group is similar to that of each of X²¹ and X²² in Chem. 4 described above.

(R³¹ and R³²)

It is sufficient that R³¹ and R³² in Chem. 6 each represent a univalent group. Each of R³¹ and R³² is not specifically limited, and one example thereof is a halogen group or a hydrocarbon group that optionally includes a substituent group. The halogen group and the hydrocarbon group that optionally includes a substituent group are each similar to that of R²¹ in Chem. 4 described above.

(R³¹ and R³⁴)

It is sufficient that R³³ and R³⁴ in Chem. 7 each represent a univalent group. Each of R³³ and R³⁴ is not particularly limited, and one example thereof is a halogen group or a hydrocarbon group that optionally includes a substituent group. The halogen group and the hydrocarbon group that optionally includes a substituent group are each similar to that of R²¹ in Chem. 4 described above.

(Y⁰¹ and Y⁰²)

Y⁰¹ and Y⁰² in Chem. 2 each independently represent, for example, a hydrogen group (—H), a hydroxy group (—OH), a halogen group (—X), a carboxylic group (—COOH), an ester group (—COOR), or a hydrocarbon group that optionally includes a substituent group.

The halogen group is, for example, a fluorine group (—F), a chlorine group (—Cl), a bromine group (—Br), or an iodine group (—I).

Carbon number of the hydrocarbon group that optionally includes a substituent group is, for example, 1 or greater and 15 or less, 1 or greater and 13 or less, 1 or greater and 12 or less, 1 or greater and 10 or less, 1 or greater and 6 or less, or 1 or greater and 3 or less.

Examples of a substituent group that optionally includes a hydrocarbon group include a halogen group (e.g., a fluorine group), an alkyl group including a halogen group (e.g., a fluorine group), and the like. The hydrocarbon group that optionally includes a substituent group may be a hydrocarbon group in which a part of carbon of the hydrocarbon group (e.g., a part of carbon included in a main chain of the hydrocarbon group) is substituted by an element such as oxygen.

In Chem. 2, it is preferable that one of (Y¹)ₙ₀₁ and/or one of (Y⁰²)ₙ₀₂ each represent a hydroxy group (—OH). One of (Y⁰¹)ₙ₀₁ and/or one of (Y⁰²)ₙ₀₂ each representing a hydroxy group (—OH) makes it possible to improve display quality and light resistance.

(Y¹¹, Y¹², Y¹³, and Y¹⁴)

In Chem. 3, binding positions of Y¹¹ and Y¹² to the benzene ring are not specifically limited. In other words, the binding positions of Y¹¹ and Y¹² to the benzene ring may be any one of an ortho position, a meta position, or a para position. Similarly, in Chem. 3, binding positions of Y¹³ and Y¹⁴ to the benzene ring are not specifically limited either. In other words, the binding positions of Y¹³ and Y¹⁴ to the benzene ring may also be any one of an ortho position, a meta position, or a para position. In Chem. 3, the binding positions of Y¹¹ and Y¹² to one benzene and the binding positions of Y¹³ and Y¹⁴ to the other benzene may be the same as or different from each other.

Y¹, Y¹², Y¹³, and Y¹⁴ in Chem. 3 each independently represent, for example, a hydrogen group (—H), a hydroxy group (—OH), a halogen group, a carboxylic group (—COOH), an ester group (—COOR), or a hydrocarbon group that optionally includes a substituent group. The halogen group or the hydrocarbon group that optionally includes a substituent group are each similar to that of each of Y⁰¹ and Y⁰² in Chem. 2 described above.

In Chem. 3, it is preferable that Y¹¹ and/or Y¹³ each represent a hydroxy group (—OH). Y¹¹ and/or Y¹³ each representing a hydroxy group (—OH) makes it possible to improve display quality and light resistance.

(Z⁰¹ and Z⁰²)

Z⁰¹ and Z⁰² in Chem. 2 each independently represent, for example, a urea bond (—NHCONH—), an amide bond (—NHCO— or —OCHN—), or a hydrazide bond (—NHCOCONH—). In terms of improvement in high-temperature high-humidity storage characteristics, it is preferable that Z⁰¹ and Z⁰² each represent a urea bond. In a case where Z⁰¹ represents an amide bond, nitrogen included in the amide bond may be bound to benzene, or carbon included in the amide bond may be bound to benzene. In a case where Z⁰² represents an amide bond, nitrogen included in the amide bond may be bound to benzene, or carbon included in the amide bond may be bound to benzene.

(Z¹¹ and Z¹²)

Z¹¹ and Z¹² in Chem. 3 each independently represent, for example, a urea bond (—NHCONH—), an amide bond (—NHCO— or —OCHN—), or a hydrazide bond (—NHCOCONH—). In terms of improvement in high-temperature high-humidity storage characteristics, it is preferable that Z¹¹ and Z¹² each represent a urea bond. In a case where Z¹ represents an amide bond, nitrogen included in the amide bond may be bound to benzene, or carbon included in the amide bond may be bound to benzene. In a case where Z¹² represents an amide bond, nitrogen included in the amide bond may be bound to benzene, or carbon included in the amide bond may be bound to benzene.

In addition to those materials, examples of the color developing/reducing agent include 4,4′-isopropylidene bisphenol, 4,4′-isopropylidene bis(o-methylphenol), 4,4′-secondary-butylidenebisphenol, 4,4′-isopropylidene bis(2-tertiary-butylphenol), zinc p-nitrobenzoate, 1,3,5-tris(4-tertiary-butyl-3-hydroxy-2,6-dimethylbenzyl)isocyanurate, 2,2-(3,4′-dihydroxydiphenyl)propane, bis(4-hydroxy-3-methylphenyl)sulfide, 4-{β-(p-methoxyphenoxy)ethoxy}salicylate, 1,7-bis(4-hydroxyphenylthio)-3,5-dioxaheptane, 1,5-bis(4-hydroxyphenylthio)-5-oxapentane, monobenzylester phthalate monocalcium salt, 4,4′-cyclohexylidenediphenol, 4,4′-isopropylidene bis(2-chlorophenol), 2,2′-methylenebis(4-methyl-6-tertiary-butylphenol), 4,4′-butylidenebis(6-tertiary-butyl-2-methyl)phenol, 1,1,3-tris(2-methyl-4-hydroxy-5-tertiary-butylphenyl)butane, 1,1,3-tris(2-methyl-4-hydroxy-5-cyclohexylphenyl)butane, 4,4′-thiobis(6-tertiary-butyl-2-methyl)phenol, 4,4′-diphenolsulfone, 4-isopropoxy-4′-hydroxydiphenyl sulfone(4-hydroxy-4′-isopropoxydiphenyl sulfone), 4-benzyloxy-4′-hydroxydiphenyl sulfone, 4,4′-diphenol sulfoxide, isopropyl p-hydroxybenzoate, benzyl p-hydroxybenzoate, benzyl protocatechuate, stearyl gallate, lauryl gallate, octyl gallate, 1,3-bis(4-hydroxyphenylthio)-propane, N,N-diphenylthiourea, N,N′-di(m-chlorophenyl)thiourea, salicylanilide, bis(4-hydroxyphenyl)acetic acid methyl ester, bis(4-hydroxyphenyl)acetic acid benzyl ester, 1,3-bis(4-hydroxycumyl)benzene, 1,4-bis(4-hydroxycumyl)benzene, 2,4′-diphenolsulfone, 2,2′-diallyl-4,4′-diphenolsulfone, 3,4-dihydroxyphenyl-4′-methyldiphenyl sulfone, 1-acetyloxy-2-zinc naphthoate, 2-acetyloxy-1-zinc naphthoate, 2-acetyloxy-3-zinc naphthoate, α,α-bis(4-hydroxyphenyl)-α-methyltoluene, antipyrine complex of zinc thiocyanate, tetrabromobisphenol A, tetrabromobisphenol S, 4,4′-thiobis(2-methylphenol), 4,4′-thiobis(2-chlorophenol), dodecylphosphonic acid, tetradecylphosphonic acid, hexadecylphosphonic acid, octadecylphosphonic acid, eicosylphosphonic acid, docosylphosphonic acid, tetracosylphosphonic acid, hexacosylphosphonic acid, octacosylphosphonic acid, α-hydroxydodecylphosphonic acid, α-hydroxytetradecylphosphonic acid, α-hydroxyhexadecylphosphonic acid, α-hydroxyoctadecylphosphonic acid, α-hydroxyeicosylphosphonic acid, α-hydroxydocosylphosphonic acid, α-hydroxytetracosylphosphonic acid, dihexadecyl phosphate, dioctadecyl phosphate, dieicosyl phosphate, didocosyl phosphate, monohexadecyl phosphate, monooctadecyl phosphate, monoeicosyl phosphate, monodocosyl phosphate, methylhexadecyl phosphate, methyloctadecyl phosphate, methyleicosyl phosphate, methyldocosyl phosphate, amylhexadecyl phosphate, octylhexadecyl phosphate, laurylhexadecyl phosphate, and the like. For each of the recording layers 13, 15, and 17, as the color developing/reducing agent, one kind of the compounds described above may be used alone, or two or more kinds of the compounds described above may be used in combination.

The photothermal conversion agent absorbs, for example, light in a predetermined wavelength region of the near-infrared region and generates heat. As the photothermal conversion agent, for example, it is preferable to use, for example, a near-infrared absorbing dye that has an absorption peak within a wavelength range of 700 nm or greater and 2500 nm or less and hardly has absorption in a visible region. Specific examples thereof include a compound having a phthalocyanine framework (a phthalocyanine-based dye), a compound having naphthalocyanine framework (a naphthalocyanine-based dye), a compound having a squarylium framework (a squarylium-based dye), a metal complex such as a dithio complex, a diimonium salt, an aminium salt, an inorganic compound, and the like. Examples of the inorganic compound include: graphite; carbon black; metal particle powder; a metal oxide such as tricobalt tetraoxide, iron oxide, chromium oxide, copper oxide, titanium black, or ITO; a metal nitride such as niobium nitride; a metal carbide such as tantalum carbide; a metal sulfide; various kinds of magnetic powder; and the like. In addition to these materials, a compound that has a cyanine framework having superior light resistance and superior heat resistance (a cyanine-based dye) may be used.

It is to be noted that the superior light resistance means that no decomposition is caused during laser irradiation. The superior heat resistance means that, for example, a film is formed together with a matrix resin (a polymer material), and, for example, when the film is stored at 150° C. for 30 minutes, a maximum absorption peak value in an absorption spectrum is not changed by 20% or more. Examples of such a compound having a cyanine framework include a compound including, in a molecule, at least one of a counter ion or a methine chain including a five-membered ring or a six-membered ring. The counter ion includes any of SbF₆, PF₆, BF₄, ClO₄, CF₃SO₃, or (CF₆SO₃)₂N.

The cyanine-based dye preferably includes both any of the counter ions described above, and a cyclic structure such as a five-membered ring or a six-membered ring in a methine chain; however, if the cyanine-based dye includes at least one of them, sufficient light resistance and sufficient heat resistance are secured. A material having superior light resistance and superior heat resistance is not decomposed during laser irradiation, as described above. Examples of a means of confirming light resistance include a method of measuring a change in a peak of an absorption spectrum during a xenon lamp irradiation test. If a change rate at the time of irradiation for 30 minutes is 20% or less, light resistance can be determined as being superior. Examples of a means of confirming heat resistance include a method of measuring a change in a peak of an absorption spectrum during storage at 150° C. If a change rate after a test for 30 minutes is 20% or less, heat resistance can be determined as being superior.

As the matrix resin (the polymer material), it is preferable to use a matrix resin (a polymer material) in which the coloring compound, the color developing/reducing agent, and the photothermal conversion agent are easily homogeneously dispersed. In addition, in order to obtain high visibility of information to be written to the recording layers 13, 15, and 17, the matrix resin (the polymer material) preferably has high transparency, and, for example, a polymer material having high solubility in an organic solvent is preferable. Examples of the matrix resin (the polymer material) include a thermosetting resin and a thermoplastic resin. Specific examples thereof include polyvinyl chloride, polyvinyl acetate, a vinyl chloride-vinyl acetate copolymer, ethyl cellulose, polystyrene, a styrene-based copolymer, a phenoxy resin, polyester, aromatic polyester, polyurethane, polycarbonate, polyacrylic acid ester, polymethacrylic acid ester, an acrylic acid-based copolymer, a maleic acid-based polymer, polyvinyl alcohol, modified polyvinyl alcohol, hydroxyethyl cellulose, carboxymethyl cellulose, starch, and the like.

The recording layers 13, 15, and 17 each include at least one kind of the coloring compounds described above, at least one kind of the color developing/reducing agents described above, and at least one kind of the photothermal conversion agents described above. It is preferable that a ratio between the coloring compound and the color developing/reducing agent included in each of the recording layers 13, 15, and 17 be, for example, the coloring compound:the color developing/reducing agent=1:2 (weight ratio). The photothermal conversion agent is changed in accordance with film thicknesses of the recording layers 13, 15, and 17. In addition, the recording layers 13, 15, and 17 may include, for example, any of various kinds of additives including, without limitation, a sensitizer, an ultraviolet absorber, and the like, in addition to the materials described above.

A ratio of the color developing/reducing agent to a total amount of the color developing/reducing agent and the matrix resin (the polymer material) is measured as follows. The compositions of the color developing/reducing agent and the matrix resin (the polymer material) in the recording layer are measured by performing mapping by means of a Fourier-transform infrared spectroscopy (an FTIR microscope). Alternatively, it is measured, based on a difference in solubility between the color developing/reducing agent and the matrix resin (the polymer compound), by measuring weights while dissolving each of them in an appropriate organic solvent.

The protective layer 18 may have a function of suppressing mixing of water, oxygen, or both into the recording layers 13, 15, and 17. The protective layer 18 covers a surface of the recording layer 17. The protective layer 18 preferably has, for example, a water vapor permeability of 0.001 g/m²/day or more and 10 g/m²/day or less. In addition, in order to obtain high visibility of information written to the recording layers 13, 15, and 17, the protective layer 18 preferably has high transparency, as with the matrix resin (the polymer material) included in the recording layers 13, 15, and 17. Examples of such a protective layer 18 include a stacked film in which an inorganic oxide film is provided on a base material including a plastic film. The protective layer 18 configured as the stacked film of the plastic film and the inorganic oxide film so covers the recording layer 17, for example, that the inorganic oxide film is disposed on the recording layer 17 side (an inner side) and the plastic film is disposed on an outer side.

As the plastic film serving as the base material, for example, an industrial plastic film may be used. The plastic film may include, for example, at least one kind of polyethylene terephthalate (PET), polycarbonate (PC), or a polymethyl methacrylate (PMMA). The plastic film preferably has, for example, a thickness of 5 μm or greater and 100 μm or less.

Examples of the inorganic oxide film include a single-layer film or a stacked film including at least one kind of a silicon oxide film (a SiOₓ film) formed by a method such as a sputtering method or a chemical vapor deposition (Chemical Vapor Deposition: CVD) method, an aluminum oxide film (an AlOₓ film) formed by such a method, or a silicon nitride film (a SiNₓ film) formed by such a method. The protective layer 18 preferably has, for example, a thickness of 10 nm or greater and 1 μm or less.

Next, a description is given of an example of writing of information in the drawing system 100.

First, the user prepares the color-undeveloped recording medium 10 and places the recording medium 10 on the Y stage 57. Next, the user sends input image data described in the RGB color space from the terminal device to the drawing system 100 via the network. Upon receiving the input image data via the network, the drawing system 100 performs the following drawing process.

First, upon receiving the input image data via the communication section 110, the information processor 160 converts the input image data described in the RGB color space into leuco image data described in the leuco color space. Thereafter, the information processor 160 derives a voltage value file (a list of command voltage values) on the basis of gradation values of respective colors of each drawing coordinate of the leuco image data obtained by the conversion. The information processor 160 transmits the derived voltage value file (the list of command voltage values) to the drawing section 150.

The signal processing circuit 51 of the drawing section 150 acquires, as the image signal Din, the voltage value file (the list of command voltage values) inputted from the information processor 160. The signal processing circuit 51 generates, from the image signal Din, an image signal corresponding to characteristics such as the wavelength of the laser light beam in synchronization with the scanner operation of the X scanner section 55. The signal processing circuit 51 converts, in the generated image signal, an image signal for one line corresponding to one time of the scanner operation into a continuous signal for continuously outputting the laser light beam over time. The signal processing circuit 51 outputs the thus generated projection image signal to the laser driving circuit 52 of the drawing section 150. The projection image signal is a signal for causing each of the light sources 53A, 53B, and 53C to continuously output the laser light beam for one line over time, and is not a signal for causing each of the light sources 53A, 53B, and 53C to discontinuously output the laser light beam for one line.

The laser driving circuit 52 drives the light sources 53A, 53B, and 53C of the light source section 53 in accordance with the projection image signals corresponding to the respective wavelengths. In this case, the laser driving circuit 52 causes, for example, a laser light beam to be emitted from at least one light source out of the light source 53A, the light source 53B, or the light source 53C, and to scan the recording medium 10.

For example, in a case of causing the recording layer 13 to develop a color, the recording layer 13 is irradiated with the laser light beam La having the light emission wavelength λ1 with such energy that the recording layer 13 reaches a color-developing temperature. Accordingly, the photothermal conversion agent included in the recording layer 13 generates heat to cause a color reaction (a color-developing reaction) between the coloring compound and the color developing/reducing agent, thereby developing, for example, a magenta color in an irradiated portion. Likewise, in a case of causing the recording layer 15 to develop a color, the recording layer 15 is irradiated with the laser light beam Lb having the light emission wavelength λ2 with such energy that the recording layer 15 reaches a color-developing temperature to develop, for example, a cyan color in an irradiated portion. In a case of causing the recording layer 17 to develop a color, the recording layer 17 is irradiated with the laser light beam Lc having the light emission wavelength λ3 with such energy that the recording layer 17 reaches a color-developing temperature to develop, for example, a yellow color in an irradiated portion. Thus, irradiating any portion with a laser light beam having a corresponding wavelength makes it possible to record a figure or the like (e.g., a full-color figure or the like).

A mechanism including the X scanner driving circuit 54, the X scanner section 55, the Y stage driving circuit 56, and the Y stage 57 functions as a scanning section that irradiates the surface of the recording medium 10 with the laser light beam Lm generated by the light source section 53. An irradiation spot of the laser light beam Lm preferably has such a size and a shape that a high-temperature region generated in and around the recording layer 13 by the laser light beam La included in the laser light beam Lm and a high-temperature region generated in and around the recording layer 15 by the laser light beam Lb included in the laser light beam Lm do not overlap with each other. In addition, the irradiation spot of the laser light beam Lm preferably has such a size and a shape that the high-temperature region generated in and around the recording layer 15 by the laser light beam Lb included in the laser light beam Lm and a high-temperature region generated in and around the recording layer 17 by the laser light beam Lc included in the laser light beam Lm do not overlap with each other.

Next, a description is given of a drawing mark to be formed on the recording medium 10 by the drawing system 100.

(A) of FIG. 4, (A) of FIG. 5, and (A) of FIG. 6 each illustrates an example of a change in power of the laser light beam Lm over time when information is written by the drawing section 150 to the recording medium 10. (B) of FIG. 4 illustrates an example of the drawing mark when drawing is performed with the power indicated in (A) of FIG. 4. (B) of FIG. 5 illustrates an example of the drawing mark when drawing is performed with the power indicated in (A) of FIG. 5. (B) of FIG. 6 illustrates an example of the drawing mark when drawing is performed with the power indicated in (A) of FIG. 6. (A) of FIG. 4, (A) of FIG. 5, and (A) of FIG. 6 each illustrate an example of light intensity of the laser light beam Lm outputted in the scanner operation for one time. (B) of FIG. 4, (B) of FIG. 5, and (B) of FIG. 6 each illustrate an example of the drawing mark generated by the scanner operation for one time.

For example, in a case where the laser light beam Lm is outputted at constantly high intensity as indicated in (A) of FIG. 4, for example, the drawing mark having a band shape with a uniform width is formed as indicated in (B) of FIG. 4. For example, in a case where the laser light beam Lm is outputted at gradually increasing intensity as indicated in (A) of FIG. 5, for example, the drawing mark having a band shape with a gradually increasing width is formed as indicated in (B) of FIG. 5. For example, in a case where the laser light beam Lm is outputted at increasing and decreasing intensity as indicated in (A) of FIG. 6, for example, the drawing mark having a band shape with an increasing and decreasing width is formed as indicated in (B) of FIG. 6. As described above, the line width of the band-shaped drawing mark formed on the recording medium 10 by the drawing system 100 has a size depending on the gradation values of respective colors of each drawing coordinate of the leuco image data. Accordingly, a striped pattern having irregular widths is formed in the image drawn on the recording medium 10 by the drawing system 100.

The striped pattern typically refers to a pattern including a plurality of lines that continuously extends in a predetermined direction (a first direction) and is arranged side by side in a direction (a second direction) orthogonal to the first direction at predetermined intervals. It is to be noted that each of the lines in the striped pattern may have shading in the first direction. In addition, each of the lines in the striped pattern may include a plurality of finely thin lines each having an aspect ratio of greater than 1 (e.g., 2 or greater). The “aspect ratio of greater than 1” refers to that (the length in the first direction/the length in the second direction) is greater than 1 where the first direction is a longitudinal direction and the second direction is a lateral direction. That is, the striped pattern does not encompass a cyclical pattern (a dotted pattern) including a plurality of dots each having a substantially equivalent aspect ratio. In the striped pattern, a pitch in the first direction is not the same as a pitch recognizable in the second direction. The pitch in the first direction is too small for a human to visually recognize, and has a size of about several micrometers, for example.

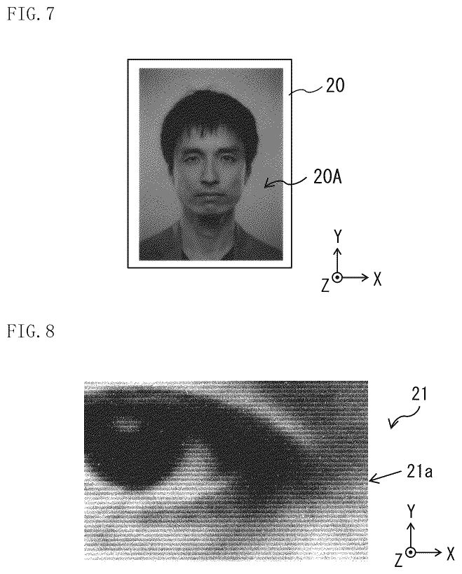

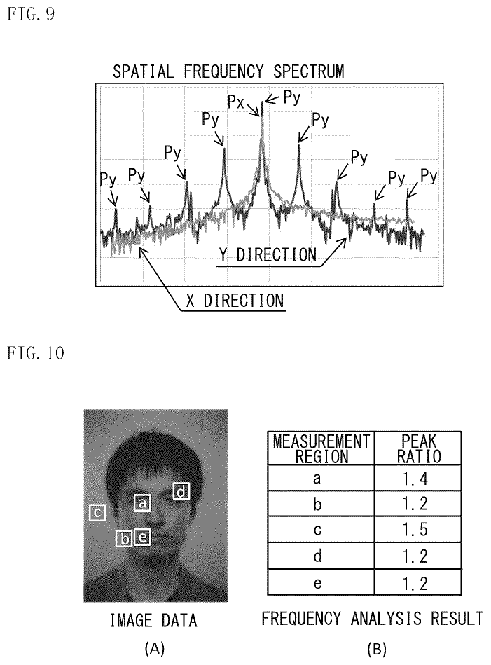

FIG. 7 illustrates an example of a drawing object 20 formed by irradiating the recording medium 10 with the laser light beam Lm. An image 20A formed by the irradiation with the laser light beam Lm is visually recognizable on a surface of the drawing object 20. The image 20A is formed by continuously irradiating the recording layers 13, 15, and 17 of the recording medium 10 with the laser light beam Lm in a scanning direction. The image 20A is formed at a position at a predetermined depth from the surface of the recording medium 10.

FIG. 8 illustrates an example of image data 21 to be obtained by performing imaging of the drawing object 20 (the image 20A). FIG. 8 illustrates, in an enlarged manner, only a portion (near a punctum) of the image 20A of the image data 21. The image data 21 includes a striped pattern 21a extending in the X direction and having irregular widths. The striped pattern 21a is formed by the irradiation with the laser light beam Lm. Accordingly, the image 20A of the drawing object 20 includes the striped pattern 21a, which is formed by the irradiation with the laser light beam Lm, extending in the X direction and having irregular widths. In other words, the striped pattern 21a extending in the X direction and having the irregular widths is drawn on each of the recording layers 13, 15, and 17 of the recording medium 10, as a drawing mark resulting from continuously irradiating the surface of the recording medium 10 with the laser light beam Lm in the scanning direction. In this case, the striped pattern 21a is a pattern in which the respective color-developed portions of the recording layers 13, 15, and 17 are superimposed.

It is to be noted that in a case where the image 20A is an image including a person's face, the X direction (an extending direction of the striped pattern 21a) may be, for example, a direction parallel to a line segment connecting two eyes included in the image. In addition, in the case where the image 20A is the image including the person's face, the Y direction (the direction orthogonal to the extending direction of the striped pattern 21a) may be, for example, a direction orthogonal to the line segment connecting the two eyes included in the image. In this case, the recording medium 10 may have a quadrangular shape in plan view, or may have a shape (e.g., a polygonal shape, a circular shape, an elliptical shape, etc.) different from the quadrangular shape in plan view.

For example, the image data 21 is obtainable by performing imaging with use of ring illumination. In a case where image data is acquired with use of usual illumination (e.g. simultaneous radiation), it is difficult to read the striped pattern 21a included in the image 20A from the image data, due to reflection of light on the surface of the recording medium 10 (the protective layer 18). In contrast, in a case where the ring illumination is used, it is possible to reduce an influence of the reflection of light on the surface of the recording medium 10 (the protective layer 18), which makes it relatively easier to read the striped pattern 21a included in the image 20A from the image data.

FIG. 9 illustrates an example of a spatial frequency spectrum of the image data 21. In FIG. 9, the spatial frequency spectrum of the image data 21 in the X direction and the spatial frequency spectrum of the image data 21 in the Y direction are overlapped with each other. The spatial frequency spectrum of the image data 21 in the X direction includes one large peak Px. In contrast, the spatial frequency spectrum of the image data 21 in the Y direction includes cyclical peaks Py not included in the spatial frequency spectrum of the image data 21 in the X direction. Thus, the striped pattern 21a is drawn on each of the recording layers 13, 15, and 17 of the recording medium 10 in a state where, in the spatial frequency spectrum of the image data 21, the profile in the Y direction orthogonal to the X direction includes the cyclical peaks Py not included in the profile in the X direction.

(A) of FIG. 10 illustrates an example of measurement regions specified in the image data 21. In (A) of FIG. 10, specified as the measurement regions are the vicinity of the punctum (a measurement region a), the vicinity of an outline of the cheek (a measurement region b), a background not including the person (a measurement region c), the vicinity of the corner of the eye (a measurement region d), and the vicinity of the edge of the lip (a measurement region e). (B) of FIG. 10 illustrates an example of a peak ratio in each of the measurement regions. The peak ratio refers to an intensity ratio at a position of one of the peaks Py in a case where the spatial frequency spectrum in the X direction and the spatial frequency spectrum of the image data 21 in the Y direction are overlapped with each other.

On the basis of (B) of FIG. 10, it is assumable that the striped pattern 21a is drawn on each of the recording layers 13, 15, and 17 of the recording medium 10 in a manner where the above-described intensity ratio satisfies the following expression.

S2/S1≥1.2
S1: the intensity, of the profile in the X direction, at the position of the one of the peaks Py
S2: the intensity, of the profile in the Y direction, at the position of the one of the peaks Py
S2/S1: the above-described intensity ratio

The drawing section 150 is configured to so draw the image 20A including the striped pattern 21a on each of the recording layers 13, 15, and 17 of the recording medium 10 that the above-described features are obtained.

Next, a description is given of an example of a method of forming the drawing object 20 by the drawing system 100. First, the user places, on the Y stage 57, the recording medium 10 that has not been processed yet (that has not been subjected to drawing yet). Thereafter, the user instructs the drawing system 100 to perform drawing on the recording medium 10. In response thereto, the drawing system 100 continuously irradiates the recording medium 10 with the laser light beam Lm to form the striped pattern extending in the X direction and having the irregular widths as the drawing mark on each of the plurality of heat-sensitive recording layers (the recording layers 13, 15, and 17). At this time, the drawing system 100 temporarily stops the irradiation with the laser light beam Lm each time the irradiation with the laser light beam Lm for one line is finished, and moves the Y stage 57 in the Y direction by a predetermined amount to allow for the irradiation with the laser light beam Lm for the next line. Upon finishing moving the Y stage 57, the drawing system 100 continuously irradiates the recording medium 10 with the laser light beam Lm again.

For example, in the drawing process described above, the drawing system 100 draws the striped pattern 21a on each of the plurality of heat-sensitive recording layers (the recording layers 13, 15, and 17) to allow, in the spatial frequency spectrum of the image data 21 obtained by performing the imaging of the striped pattern 21a with the use of the ring illumination, the spatial frequency profile in the Y direction to include the cyclical peaks Py not included in the spatial frequency profile in the X direction. For example, the drawing system 100 draws the striped pattern 21a on each of the plurality of heat-sensitive recording layers (the recording layers 13, 15, and 17) to allow the intensity ratio at the position of one of the peaks Py to satisfy the above-described expression (S2/S1≥1.2) when the spatial frequency profile in the X direction and the spatial frequency profile in the Y direction are overlapped with each other. For example, the drawing system 100 draws the striped pattern 21a on each of the plurality of heat-sensitive recording layers (the recording layers 13, 15, and 17) to allow the X direction to be the direction parallel to one end side of the recording medium 10 and the Y direction to be the direction parallel to the other end side orthogonal to the foregoing end side of the recording medium 10. The drawing object 20 is formed in the above-described manner.

### [Effects]

Next, a description is given of effects of the drawing system 100.

A recording medium on which reversible recording and erasing of information are performed by heat, that is, what is called a reversible heat-sensitive recording medium has been developed as a display medium in place of printed matters. In the reversible heat-sensitive recording medium, for example, a plurality of reversible heat-sensitive recording layers different from each other in photothermal conversion wavelength is stacked with a heat-insulating layer interposed therebetween. A reversible heat-sensitive recording medium is subjected to pulse irradiation with a laser light beam having a predetermined wavelength to selectively generate heat at a specific reversible heat-sensitive recording layer and allow the specific reversible heat-sensitive recording layer to be colored or decolored by the action of the generated heat, which allows for recording or erasing of information (see PTL 1, for example).

Incidentally, in PTL 1, in a case where drawing is to be performed at a higher resolution on a reversible heat-sensitive recording layer, it is necessary to reduce an irradiation area per pixel and to perform irradiation with a laser light beam at a higher energy density. Meanwhile, a semiconductor laser is limited in power. Accordingly, an insufficiency of laser power can cause a problem that desired image quality is not obtainable.

In contrast, in the present embodiment, the recording layers 13, 15, and 17 each have the striped pattern 21a drawn as the drawing mark resulting from continuously irradiating the surface of the recording medium 10 with the laser light beam Lm in the scanning direction. The striped pattern 21a extends in the X direction and has the irregular widths. This achieves a high resolution in the Y direction orthogonal to the extending direction of the striped pattern 21a. Meanwhile, the resolution is lower in the X direction parallel to the extending direction of the striped pattern 21a than in the Y direction. However, in the drawing by means of the continuous irradiation with the laser light beam Lm, it is possible to perform drawing in a striped shape by means of heat transfer (drawing by a continuous power control). It is therefore possible to achieve desired image quality with low power, as compared with drawing in a dotted shape by means of pulse irradiation with the laser light beam (drawing by a discontinuous power control). It is therefore possible to achieve high image quality with low power.

In addition, in the present embodiment, the striped pattern 21a is drawn on each of the recording layers 13, 15, and 17 in a state where, in the spatial frequency spectrum of the image data 21, the profile in the Y direction orthogonal to the X direction includes the cyclical peaks Py not included in the profile in the X direction. Here, the intensity ratio at the position of one of the peaks Py when the profile in the X direction and the profile in the Y direction are overlapped with each other satisfies S2/S1≥1.2. This achieves a high resolution in the Y direction orthogonal to the extending direction of the striped pattern 21a. Meanwhile, the resolution is lower in the X direction parallel to the extending direction of the striped pattern 21a than in the Y direction. However, in the drawing by means of the continuous irradiation with the laser light beam Lm, it is possible to perform drawing in the striped shape by means of heat transfer. It is therefore possible to achieve desired image quality with low power, as compared with drawing in a dotted shape by means of pulse irradiation with the laser light beam. It is therefore possible to achieve high image quality with low power.

In addition, in the present embodiment, the drawing object 20 is formed by forming, as the drawing mark, the striped pattern 21a on each of the recording layers 13, 15, and 17 by continuously irradiating the recording medium 10 with the laser light beam Lm in the scanning direction. The striped pattern 21a extends in the X direction and has the irregular widths. This achieves a high resolution in the Y direction orthogonal to the extending direction of the striped pattern 21a. Meanwhile, the resolution is lower in the X direction parallel to the extending direction of the striped pattern 21a than in the Y direction. However, in the drawing by means of the continuous irradiation with the laser light beam Lm, it is possible to perform drawing in the striped shape by means of heat transfer. It is therefore possible to achieve desired image quality with low power, as compared with drawing in a dotted shape by means of pulse irradiation with the laser light beam. Accordingly, it is possible to achieve high image quality with low power.

In addition, in the present embodiment, in the drawing process, the striped pattern 21a is drawn on each of the recording layers 13, 15, and 17 to allow, in the spatial frequency spectrum of the image data 21, the profile in the Y direction orthogonal to the X direction to include the cyclical peaks Py not included in the profile in the X direction. Here, the intensity ratio at the position of one of the peaks Py when the profile in the X direction and the profile in the Y direction are overlapped with each other satisfies S2/S1≥1.2. This achieves a high resolution in the Y direction orthogonal to the extending direction of the striped pattern 21a. Meanwhile, the resolution is lower in the X direction parallel to the extending direction of the striped pattern 21a than in the Y direction. However, in the drawing by means of the continuous irradiation with the laser light beam Lm, it is possible to perform drawing in the striped shape by means of heat transfer. It is therefore possible to achieve desired image quality with low power, as compared with drawing in a dotted shape by means of pulse irradiation with the laser light beam. It is therefore possible to achieve high image quality with low power.

### 2. Modification Examples

In the following, a description is given of modification examples of the drawing system 100 according to the embodiment of the present disclosure.

### Modification Example A

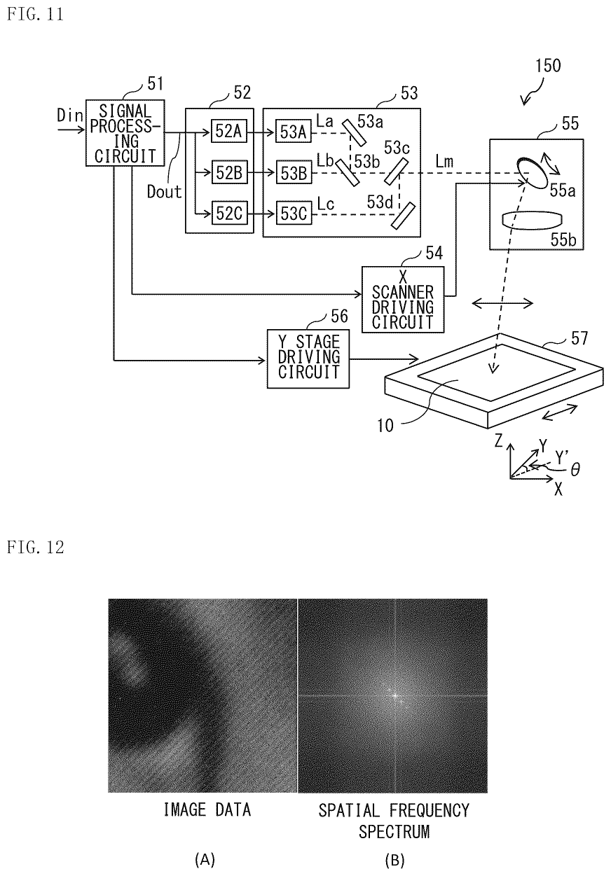

FIG. 11 illustrates a modification example of a schematic configuration of the drawing system 100 according to the embodiment described above. In the embodiment described above, the recording medium 10 is the sheet-shaped or plate-shaped recording medium having the quadrangular shape in plan view. The X direction is the direction parallel to one end side of the recording medium 10, and the Y direction is the direction parallel to the other end side orthogonal to the foregoing end side of the recording medium 10. However, for example, as illustrated in FIG. 11, the X direction and the Y direction may each be a direction obliquely intersecting all the end sides of the recording medium 10. In this case, the Y stage 57 is rotated by a predetermined angle θ (0<θ<90°) in the XY plane, as compared with how it is disposed in the embodiment described above. Further, the drawing system 100 draws the striped pattern 21a on each of the plurality of heat-sensitive recording layers (the recording layers 13, 15, and 17) to allow, for example, each of the X direction and the Y direction to be the direction obliquely intersecting all end sides of the recording medium 10.

(A) of FIG. 12 illustrates an example of the image data 21 of the drawing object 20 to be formed by irradiating the recording medium 10 with the laser light beam Lm by means of the drawing system 100 in FIG. 11. (B) of FIG. 12 illustrates an example of the spatial frequency spectrum of the image data. In (A) of FIG. 12, the horizontal axis represents the spatial frequency in the X direction, and the vertical axis represents the spatial frequency in the Y direction. In addition, in (A) of FIG. 12, the angle θ is 45°, and the striped pattern 21a extends in a direction intersecting all the end sides of the recording medium 10 at 45°. In (B) of FIG. 12, a plurality of bright spots is arranged side by side in one row in a direction orthogonal to the extending direction of the striped pattern 21a. In (B) of FIG. 12, each of the bright spots corresponds to one of the peaks Py described above.

In the present modification example, as with the embodiment described above, the striped pattern 21a extending in the X direction and having the irregular widths is drawn on each of the recording layers 13, 15, and 17, as the drawing mark formed by continuously irradiating the surface of the recording medium 10 with the laser light beam Lm. This achieves a high resolution in the Y direction orthogonal to the extending direction of the striped pattern 21a. Meanwhile, the resolution is lower in the X direction parallel to the extending direction of the striped pattern 21a than in the Y direction. However, in the drawing by means of the continuous irradiation with the laser light beam Lm, it is possible to perform drawing in a striped shape by means of heat transfer. It is therefore possible to achieve desired image quality with low power, as compared with drawing in a dotted shape by means of pulse irradiation with the laser light beam.

In addition, in the present modification example, as with the embodiment described above, the drawing object 20 is formed by continuously irradiating the recording medium 10 with the laser light beam Lm in the scanning direction and forming the striped pattern 21a extending in the X direction and having the irregular widths on each of the recording layers 13, 15, and 17 as the drawing mark. This achieves a high resolution in the Y direction orthogonal to the extending direction of the striped pattern 21a. Meanwhile, the resolution is lower in the X direction parallel to the extending direction of the striped pattern 21a than in the Y direction. However, in the drawing by means of the continuous irradiation with the laser light beam Lm, it is possible to perform drawing in the striped shape by means of heat transfer. It is therefore possible to achieve desired image quality with low power, as compared with drawing in a dotted shape by means of pulse irradiation with the laser light beam. Accordingly, it is possible to achieve high image quality with low power.

### Modification Example B

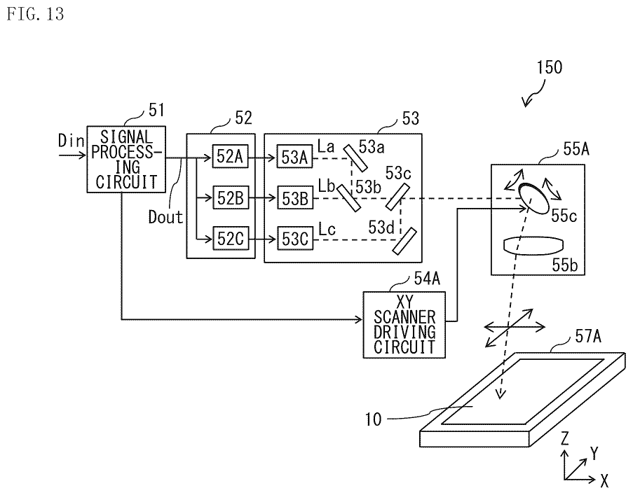

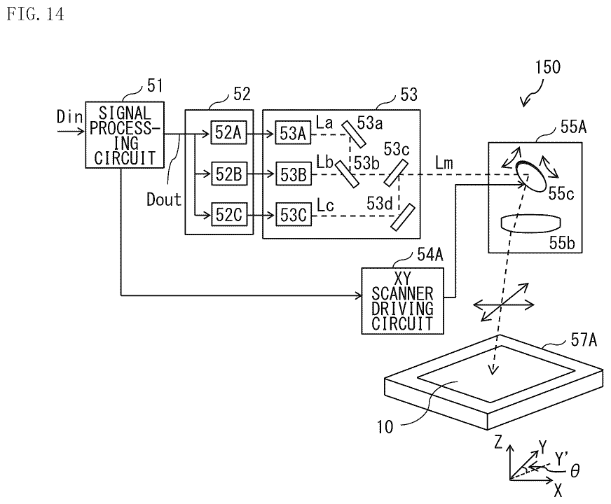

FIGS. 13 and 14 each illustrate a modification example of a schematic configuration of the drawing section 150 according to the embodiment and the modification example A described above. In the embodiment described above, raster-scanning is performed by scanning with the laser light beam Lm in the X-axis direction by the X scanner section 55 and moving the Y stage 57 in the Y-axis direction. However, in the embodiment and the modification example A described above, for example, as illustrated in FIGS. 13 and 14, the raster-scanning may be performed by using an XY scanner driving circuit 54A, an XY scanner section 55A, and a fixed stage 57A in place of the X scanner driving circuit 54, the X scanner section 55, the Y stage driving circuit 56, and the Y stage 57. It is to be noted that the drawing section 150 illustrated in FIGS. 13 and 14 may include a driving circuit that moves the fixed stage 57A, and the raster-scanning may be implemented by moving the fixed stage 57A.

The XY scanner driving circuit 54A drives the XY scanner section 55A on the basis of, for example, a control signal inputted from the signal processing circuit 51. In addition, for example, in a case where a signal regarding an irradiation angle of a two-axis scanner 55c to be described later or the like is inputted from the XY scanner section 55A, the XY scanner driving circuit 54A drives the XY scanner section 55A to cause the irradiation angle to be a desired irradiation angle on the basis of the signal.

For example, the XY scanner section 55A scans the surface of the recording medium 10 in the X-axis direction with the laser light beam Lm incident from the light source section 53, and moves a scan line in the Y-axis direction with a predetermined step width. The XY scanner section 55A includes, for example, the two-axis scanner 55c and the fθ lens 55b. The two-axis scanner 55c is, for example, a galvanometer mirror that scans the surface of the recording medium 10 in the X-axis direction with the laser light beam Lm incident from the light source section 53 on the basis of a drive signal inputted from the XY scanner driving circuit 54A and moves the scan line in the Y-axis direction with the predetermined step width. The fθ lens 55b converts a constant speed rotational motion by the two-axis scanner 55c into a constant speed linear motion of a spot moving on a focal plane (the surface of the recording medium 10). The fixed stage 57A is a stage that simply supports the recording medium 10.

The present modification example is different from the embodiment described above only in the method of implementing the raster-scanning, and is similar to the embodiment described above in that the striped pattern 21a is drawn on each of the recording layers 13, 15, and 17. Accordingly, it is possible to achieve high image quality with low power also in the present modification example.

### Modification Example C

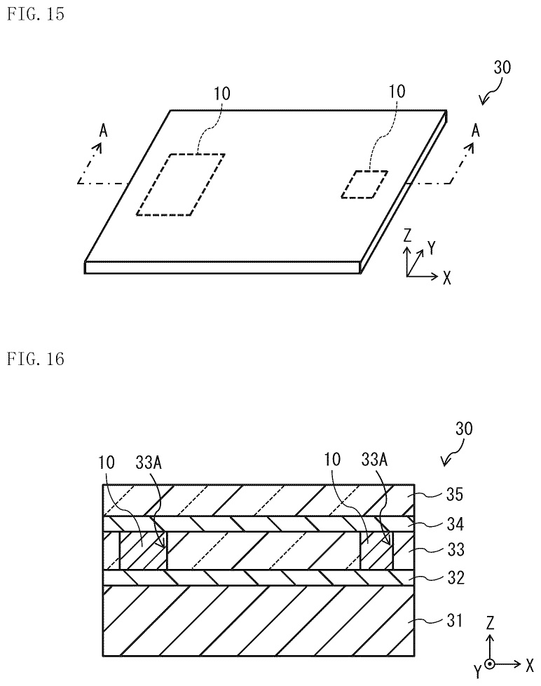

FIG. 15 illustrates an example of a perspective configuration of a stacked body 30 including one or a plurality of recording media 10 according to the embodiment and the modification examples A and B described above. FIG. 16 illustrates an example of a cross-sectional configuration taken along a line A-A in the stacked body 30 in FIG. 15.

The stacked body 30 is applicable, for example, to a housing of a medical product, an automobile part, an automobile, a toy, food, a cosmetic product, a fashion product, a document (e.g., a passport), an outer package member, an electronic apparatus, or the like. Specific examples of the outer package member include, for example: an interior or an exterior of a building, such as a wall; an exterior of furniture such as a desk; and the like. Specific examples of the electronic apparatus include a personal computer (hereinafter referred to as a “PC”), a mobile device, a mobile phone (e.g. a smartphone), a tablet computer, a display device, an imaging device, an audio device, a gaming machine, an industrial tool, a medical device, a robot, a wearable terminal, and the like. Specific examples of the wearable terminal include fashion products including a clock (or a watch), a bag, a dress, a hat, eyeglasses, shoes, and the like.

The stacked body 30 includes a base material 31, an adhesive layer 32, a spacer layer 33, an adhesive layer 34, an overlay layer 35, and one or a plurality of recording media 10. The stacked body 30 may be, for example, a card (hereinafter referred to as a “security card or the like”) such as a security card, a financial payment card, an ID card, or a private transaction card. Examples of the financial payment card include a credit card, a cash card, and the like. Examples of the ID card include a driver's license, an employee ID card, a member ID card, a student ID card, and the like. Examples of the private transaction card include a prepaid card, a reward card, and the like.

The base material 31 is a supporting body that supports the recording medium 10 and the spacer layer 33. The base material 31 may have a color such as a white color. The base material 31 may have one main surface, on side where the spacer layer 33, the recording medium 10, and the like are provided, on which a figure, a picture, a photograph, a character, a combination of two or more of them, or the like (hereinafter referred to as “the figure or the like”) is printed.

The base material 31 includes, for example, plastic. The base material 31 may include at least one kind selected from a group including a colorant, an antistatic agent, a flame retardant, a surface modifier, and the like, as necessary. A reflective layer (not illustrated) may be provided on at least one of main surfaces of the base material 31. Alternatively, the base material 31 itself may also serve as the reflective layer.

The plastic used for the base material 31 includes, for example, at least one kind selected from a group including an ester-based resin, an amide-based resin, an olefin-based resin, a vinyl-based resin, an acrylic-based resin, an imide-based resin, a styrene-based resin, engineering plastic, and the like. In a case where the base material 31 includes two or more kinds of the resins, the two or more kinds of the resins may be mixed, copolymerized, or stacked.

The ester-based resin described above includes, for example, at least one kind selected from a group including polyethylene terephthalate (PET), polybutylene terephthalate (PBT), polyethylene naphthalate (PEN), a polyethylene terephthalate-isophthalate copolymer, a terephthalic acid-cyclohexane dimethanol-ethylene glycol copolymer, and the like. The amide-based resin described above includes, for example, at least one kind selected from a group including nylon 6, nylon 66, nylon 610, and the like. The olefin-based resin described above includes, for example, at least one kind selected from a group including polyethylene (PE), polypropylene (PP), polymethylpentene (PMP), and the like. The vinyl-based resin described above includes, for example, polyvinyl chloride (PVC).

The acrylic-based resin described above includes, for example, at least one kind selected from a group including polyacrylate, polymethacrylate, polymethyl methacrylate (PMMA), and the like. The imide-based resin described above includes, for example, at least one kind selected from a group including polyimide (PI), polyamide imide (PAI), polyetherimide (PEI), and the like. The styrene-based resin described above includes, for example, at least one kind selected from a group including polystyrene (PS), high-impact polystyrene, an acrylonitrile-styrene resin (an AS resin), an acrylonitrile-butadiene-styrene resin (an ABS resin), and the like. The engineering plastic described above includes, for example, at least one kind selected from a group including polycarbonate (PC), polyarylate (PAR), polysulfone (PSF), polyethersulfone (PES), polyphenylene ether (PPE), polyphenylene sulfide (PPS), polyetherketone (PEK), polyetheretherketone (PEEK), polyphenylene oxide (PPO), polyether sulfite, and the like.

The spacer layer 33 is provided on one main surface of the base material 31. The adhesive layer 32 is interposed between the base material 31 and the spacer layer 33. The spacer layer 33 includes a containing part 33A adapted to contain the recording medium 10. The containing part 33A is provided in a portion of a plane of the spacer layer 33. The containing part 33A may be a through hole that lies through in a thickness direction of the spacer layer 33. The spacer layer 33 is adapted to suppress a level difference caused by the recording medium 10 when the recording medium 10 is interposed between the base material 31 and the overlay layer 35. The spacer layer 33 has a thickness substantially the same as that of the recording medium 10. The spacer layer 33 covers a region, of the one main surface of the base material 31, other than a region provided with the recording medium 10.

The spacer layer 33 has a film shape. The spacer layer 33 may be transparent. The spacer layer 33 includes plastic. Examples of the plastic included in the spacer layer 33 include a material similar to that included in the base material 31.

The overlay layer 35 is provided above the spacer layer 33 and the recording medium 10, and covers the spacer layer 33 and the recording medium 10. The adhesive layer 34 is interposed between each of the spacer layer 33 and the recording medium 10, and the overlay layer 35. The overlay layer 35 protects the members (i.e., the recording medium 10 and the spacer layer 33) inside the stacked body 30, and maintains mechanical reliability of the stacked body 30.

The overlay layer 35 has a film shape. The overlay layer 35 is transparent. The overlay layer 35 includes plastic. Examples of the plastic included in the overlay layer 35 include a material similar to that included in the base material 31. The overlay layer 35 may have at least one main surface on which the figure or the like is printed.

The adhesive layer 32 is provided between the base material 31 and the spacer layer 33, and adheres the base material 31 and the spacer layer 33 to each other. The adhesive layer 34 is provided between the spacer layer 33 and the overlay layer 35, and adheres the spacer layer 33 and the overlay layer 35 to each other. The adhesive layers 32 and 34 are transparent. The adhesive layers 32 and 34 include a thermal adhesive. The thermal adhesive included in the adhesive layers 32 and 34 includes a thermosetting resin. The thermosetting resin included in the adhesive layers 32 and 34 includes, for example, at least one kind selected from a group including an epoxy-based resin, a urethane-based resin, and the like. The above-described thermal adhesive preferably has a curing temperature within a temperature range of 100° C. or higher and 120° C. or lower in terms of reduction in damage to the recording medium 10.

A description is given below of an example of a method of manufacturing the stacked body 30.

First, the thermosetting resin is applied as the thermal adhesive onto one main surface of the base material 31 to form the adhesive layer 32. Thereafter, the spacer layer 33 is placed on the adhesive layer 32, following which the recording medium 10 is fitted into the containing part 33A of the spacer layer 33. It is to be noted that the spacer layer 33 in which the recording medium 10 is fitted in the containing part 33A in advance may be placed on the adhesive layer 32. In addition, the adhesive layer 32 may be formed by applying the thermosetting resin onto the spacer layer 33 in which the recording medium 10 is fitted in the containing part 33A in advance, and thereafter placing the spacer layer 33 on the main surface of the base material 31 with the coating film interposed therebetween. Alternatively, the adhesive layer 32 may be formed by adhering, by means of heat laminating or the like, a sheet to the major surface of the base material 31 or the spacer layer 33 in which the recording medium 10 is fitted in the containing part 33A in advance. The sheet may be formed by applying the thermosetting resin to a separator in advance or any other method.

Thereafter, the thermosetting resin is applied as the thermal adhesive onto the spacer layer 33 to form the adhesive layer 34, following which the overlay layer 35 is placed on the adhesive layer 34. Thereafter, the obtained stacked body 30 is interposed between metal plates, which is applied with pressure while being heated to thermally cure the adhesive layer 34. The temperature at which the stacked body 30 is subjected to the thermal curing is preferably 100° C. or higher and 120° C. or lower in terms of reduction in damage to the recording medium 10. The desired stacked body 30 is obtained in the above-described manner. The adhesive layer 34 may be formed by applying the thermosetting resin to the overlay layer 35, and thereafter placing the overlay layer 35 on the spacer layer 33 with the coating film interposed therebetween. Alternatively, the adhesive layer 34 may be formed by adhering, by means of heat laminating or the like, a sheet to the overlay layer 35 or the spacer layer 33. The sheet may be formed by applying the thermosetting resin to a separator in advance or any other method.

It is to be noted that, in the present modification example, the recording medium 10 may be provided over the entire stacked body 30 in plan view. In this case, the spacer layer 33 is omitted in the stacked body 30.

In addition, in the present modification example, the adhesive layers 32 and 34 may be omitted, the base material 31 and the spacer layer 33 may be adhered to each other by fusion bonding, and the spacer layer 33 and the overlay layer 35 may be adhered to each other by fusion bonding.

In this case, the base material 31, the spacer layer 33, and the overlay layer 35 preferably include a thermoplastic resin as the plastic. The base material 31, the spacer layer 33, and the overlay layer 35 including the thermoplastic resin makes it possible to enhance strength of interlayer adherence resulting from fusion bonding. The thermoplastic resin is preferably a thermoplastic resin that allows for thermal fusion bonding between the layers of the stacked body 30 within a temperature range of 130° C. or higher and 200° C. or lower in terms of reduction in damage to the recording medium 10.

The base material 31, the spacer layer 33, and the overlay layer 35 may include the same kind of thermoplastic resin, or may not include the same kind of thermoplastic resin. In a case where the base material 31, the spacer layer 33, and the overlay layer 35 do not include the same kind of thermoplastic resin, one of the base material 31, the spacer layer 33, and the overlay layer 35 may include a different kind of thermoplastic resin from that included in the other two layers. In the case where the base material 31, the spacer layer 33, and the overlay layer 35 do not include the same kind of thermoplastic resin, the base material 31, the spacer layer 33, and the overlay layer 35 may include respective thermoplastic resins that are different from each other in kind.

In a case where the base material 31, the spacer layer 33, and the overlay layer 35 include the same kind of thermoplastic resin, the base material 31, the spacer layer 33, and the overlay layer 35 preferably include at least one kind selected from a group including a semi-crystalline thermoplastic resin and an amorphous thermoplastic resin in terms of improvement of the strength of the interlayer adherence resulting from fusion bonding.

The semi-crystalline thermoplastic resin includes, for example, at least one kind selected from a group including polypropylene (PP), polyethylene (PE), polyacetal (POM), polyethylene terephthalate (PET), polybutylene terephthalate (PBT), polyphenylenesulfide (PPS), polyetheretherketone (PEEK), and the like.

The amorphous thermoplastic resin includes, for example, at least one kind selected from a group including an ABS resin, polycarbonate (PC), a polymer alloy of an ABS resin and PC (hereinafter referred to as an “ABS/PC polymer alloy”), an AS resin, polystyrene (PS), polymethyl methacrylate (PMMA), polyphenylene oxide (PPO), polysulfone (PSU), polyvinyl chloride (PVC), polyether imide (PEI), polyether sulfone (PES), and the like.

In the case where the base material 33, the spacer layer 33, and the overlay layer 35 do not include the same kind of thermoplastic resin, the base material 31, the spacer layer 33, and the overlay layer 35 preferably include the amorphous thermoplastic resin in terms of improvement of the strength of the interlayer adherence resulting from fusion bonding.

The combination of the amorphous thermoplastic resins included in the respective two adjacent layers in the stacked body 30 is preferably the following combination. In a case where one of the two adjacent layers in the stacked body 30 includes an ABS resin, another layer preferably includes at least one kind selected from a group including an ABS/PC polymer alloy, polycarbonate (PC), an AS resin, polystyrene (PS), polymethyl methacrylate (PMMA), and polyvinyl chloride (PVC).

In a case where one of the two adjacent layers in the stacked body 30 includes an ABS/PC polymer alloy, another layer preferably includes at least one kind selected from a group including an ABS resin, polycarbonate (PC), and polymethyl methacrylate (PMMA). In a case where one of the two adjacent layers in the stacked body 30 includes polycarbonate (PC), another layer preferably includes at least one kind selected from a group including an ABS/PC polymer alloy and polymethyl methacrylate (PMMA).

In a case where one of the two adjacent layers in the stacked body 30 includes an AS resin, another layer preferably includes at least one kind selected from a group including an ABS resin, polystyrene (PS), polymethyl methacrylate (PMMA), and polyphenylene oxide (PPO). In a case where one of the two adjacent layers in the stacked body 30 includes polystyrene (PS), another layer preferably includes at least one kind selected from a group including an AS resin and polyphenylene oxide (PPO).

In a case where one of the two adjacent layers in the stacked body 30 includes polymethyl methacrylate (PMMA), another layer preferably includes at least one kind selected from a group including an ABS resin, an ABS/PC polymer alloy, an AS resin, and polyphenylene oxide (PPO). In a case where one of the two adjacent layers in the stacked body 30 includes polyphenylene oxide (PPO), another layer preferably includes at least one kind selected from a group including polycarbonate (PC), an AS resin, polystyrene (PS), and polymethyl methacrylate (PMMA).

In a case where one of the two adjacent layers in the stacked body 30 includes polysulfone (PSU), another layer preferably includes polycarbonate (PC). In a case where one of the two adjacent layers in the stacked body 30 includes polyvinyl chloride (PVC), another layer preferably includes an ABS resin.

Next, a description is given of an example of a method of manufacturing the stacked body 30 according to the present modification example. First, the recording medium 10 is placed on one of the main surfaces of the base material 31. Thereafter, the overlay layer 35 is placed on the recording medium 10. Thereafter, the stacked body including the base material 31, the recording medium 10, and the overlay layer 35 is interposed between metal plates, which is applied with pressure while being heated to thermal-fusion-bond the base material 31 and the recording medium 10 to each other and thermal-fusion-bond the recording medium 10 and the overlay layer 35 to each other. The temperature at which the stacked body is subjected to the thermal fusion bonding is preferably 130° C. or higher and 200° C. or lower in terms of reduction in damage to the recording medium 10 and in terms of exhibition of sufficient fusion bonding strength. The stacked body 30 according to the present modification example is obtained in the above-described manner.

In the present modification example, a depression with a bottom may be provided instead of the containing part 13A. The depression with the bottom is depressed in the thickness direction of the spacer layer 33. In this case, the depression may be provided on the main surface, of the two main surfaces of the spacer layer 33, on side opposed to the overlay layer 35, or may be provided on the main surface, of the two main surfaces of the spacer layer 33, on side opposed to the base material 31.

### Modification Example D

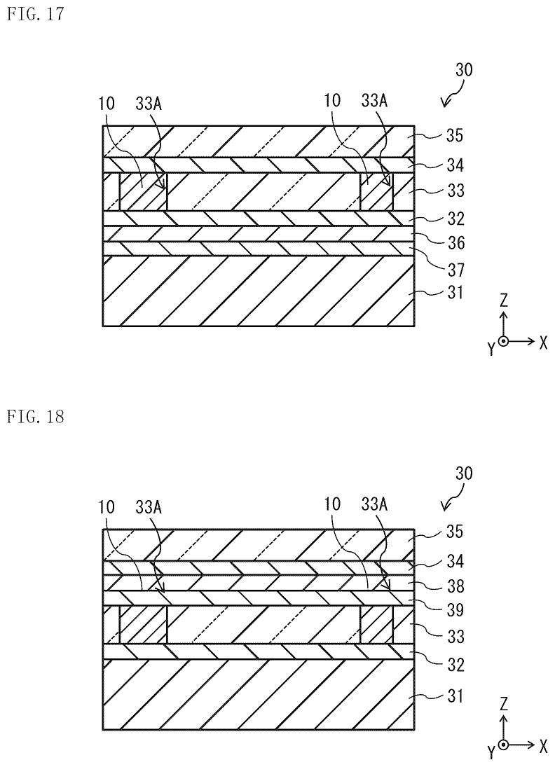

In the modification example C described above, for example, as illustrated in FIG. 17, the stacked body 30 may include a laser marking layer 36 that is different from the recording layers 13, 15, and 17 in color in the color-developed state and light absorption wavelength band. The laser marking layer 36 corresponds to one specific example of a “second heat-sensitive recording layer” according to one embodiment of the present disclosure. The laser marking layer 36 is configured to be changed in colored state by an external stimulus such as a laser light beam, heat, or the like. The laser marking layer 36 includes, for example, a material that is configured to develop a black color or a dark color by an external stimulus such as a laser light beam, heat, or the like. The laser marking layer 36 is different from the recording layers 13, 15, and 17 in recording method (in color development principle of the recording method).

The laser marking layer 36 may be a publicly known laser marking sheet. The laser marking layer 36 is, for example, a heat-sensitive recording layer on which laser marking is performable by at least one method of the following methods (1) to (5).
(1) a method in which a color is developed by causing a resin material to foam
(2) a method in which an additive absorbing a laser light beam is added to the resin material and a color is developed by the additive itself
(3) a method in which the additive absorbing a laser light beam is added to the resin material and a color is developed by causing the additive to generate heat to carbonize the resin material around the additive
(4) a method in which a surface of a resin layer is etched by laser irradiation to use a change in surface state
(5) a method in which marking is performed by irradiating a resin material colored in a black color or a dark color with a laser light beam to sublime (decompose) a colorant (carbon black) and thereby perform decolorization (expose the original color of the resin material)

The laser marking layer 36 includes, for example, a photothermal conversion agent and a resin material. The resin material included in the laser marking layer 36 includes, for example, a polycarbonate-based resin. The photothermal conversion agent included in the laser marking layer 36 absorbs light in a predetermined wavelength region of the near-infrared region and generates heat, for example. It is preferable to select, as the photothermal conversion agent included in the laser marking layer 36, for example, a photothermal conversion agent having a light absorption wavelength band that is narrow in the near-infrared region and does not overlap with the light absorption bands of the recording layers 13, 15, and 17. The photothermal conversion agent included in the laser marking layer 36 includes, for example, carbon.

The laser marking layer 36 is disposed at least at a location opposed to the recording medium 10 in the stacking direction of each of the layers in the stacked body 30. The laser marking layer 36 is disposed, for example, between the base material 31 and each of the spacer layer 33 and the recording medium 10, as illustrated in FIG. 17. In this case, the laser marking layer 36 is adhered to the base material 31 with an adhesive layer 37 interposed therebetween and is also adhered to the spacer layer 33 and the recording medium 10 with the adhesive layer 32 interposed therebetween, for example, as illustrated in FIG. 17.

In the present modification example, for example, as illustrated in FIG. 18, the stacked body 30 may include a laser marking layer 38 instead of the laser marking layer 36. The laser marking layer 38 is different from the recording layers 13, 15, and 17 in color in the color-developed state and light absorption wavelength band.

The laser marking layer 38 is configured to be changed in colored state by an external stimulus such as a laser light beam, heat, or the like. The laser marking layer 38 includes, for example, a material that is configured to develop a black color or a dark color by an external stimulus such as a laser light beam, heat, or the like. The laser marking layer 38 is different from the recording layers 13, 15, and 17 in recording method (in color development principle of the recording method).

The laser marking layer 38 may be a publicly known laser marking sheet. The laser marking layer 38 is configured, for example, to allow laser marking to be performed thereon by at least one method of the above-described methods (1) to (5).

The laser marking layer 38 includes, for example, a photothermal conversion agent and a resin material. The resin material included in the laser marking layer 38 includes, for example, a polycarbonate-based resin. The photothermal conversion agent included in the laser marking layer 38 absorbs light in a predetermined wavelength region of the near-infrared region and generates heat, for example. It is preferable to select, as the photothermal conversion agent included in the laser marking layer 38, a photothermal conversion agent having a light absorption wavelength band that is narrow in the near-infrared region and does not overlap with the light absorption bands of the recording layers 13, 15, and 17, for example. The photothermal conversion agent included in the laser marking layer 38 includes, for example, carbon.

The laser marking layer 38 is disposed at least at a location opposed to the recording medium 10 in the stacking direction of each of the layers in the stacked body 30. The laser marking layer 38 is disposed, for example, between each of the spacer layer 33 and the recording medium 10, and the overlay layer 35, as illustrated in FIG. 18. In this case, the laser marking layer 38 is adhered to the overlay layer 35 with the adhesive layer 34 interposed therebetween and is also adhered to the spacer layer 33 and the recording medium 10 with an adhesive layer 39 interposed therebetween, for example, as illustrated in FIG. 18.

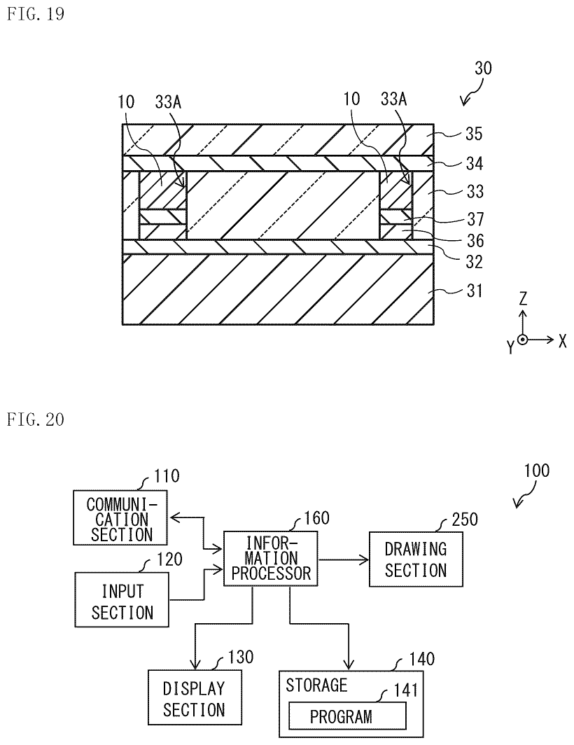

In the present modification example, the laser marking layer 36 may be disposed, for example, in the containing part 33A, as illustrated in FIG. 19. The laser marking layer 36 is disposed, for example, between the base material 31 and the recording medium 10 inside the containing part 33A. In this case, the laser marking layer 36 is adhered to the base material 31 with the adhesive layer 32 interposed therebetween and is also adhered to the recording medium 10 with the adhesive layer 37 interposed therebetween, for example, as illustrated in FIG. 19.

In the present modification example, the laser marking layer 36 or 38 may be disposed only at a location not opposed to the recording medium 10 in the stacking direction of each of the layers in the stacked body 30. In such a case, in the stacked body 30, the drawing mark on the recording medium 10 and the drawing mark on the laser marking layer 36 or 38 are visually recognized in a state where they are not overlapped with each other.

In addition, in FIG. 17, the adhesive layers 32 and 37 may be omitted, the base material 31 and the laser marking layer 36 may be adhered to each other by fusion bonding, and the laser marking layer 36 and each of the spacer layer 33 and the recording medium 10 may be adhered to each other by fusion bonding. In addition, in FIG. 17, the adhesive layer 34 may be omitted, and each of the spacer layer 33 and the recording medium 10, and the overlay layer 35 may be adhered to each other by fusion bonding.

In addition, in FIG. 18, the adhesive layer 32 may be omitted, and the base material 31 and each of the spacer layer 33 and the recording medium 10 may be adhered to each other by fusion bonding. In addition, in FIG. 18, the adhesive layers 34 and 39 may be omitted, each of the spacer layer 33 and the recording medium 10, and the laser marking layer 38 may be adhered to each other by fusion bonding, and the laser marking layer 38 and the overlay layer 35 may be adhered to each other by fusion bonding.

In addition, in FIG. 19, the adhesive layers 32 and 37 may be omitted, the base material 31 and each of the laser marking layer 36 and the spacer layer 33 may be adhered to each other by fusion bonding, and the laser marking layer 36 and the recording medium 10 may be adhered to each other by fusion bonding. In addition, in FIG. 19, the adhesive layer 34 may be omitted, and each of the spacer layer 33 and the recording medium 10, and the overlay layer 35 may be adhered to each other by fusion bonding.

FIG. 20 illustrates an example of the schematic configuration of the drawing system 100 configured to perform laser drawing on the laser marking layers 36 and 38. The drawing system 100 according to the present modification example is configured to write (draw) and erase information on the stacked body 30 including one or a plurality of recording media 10.

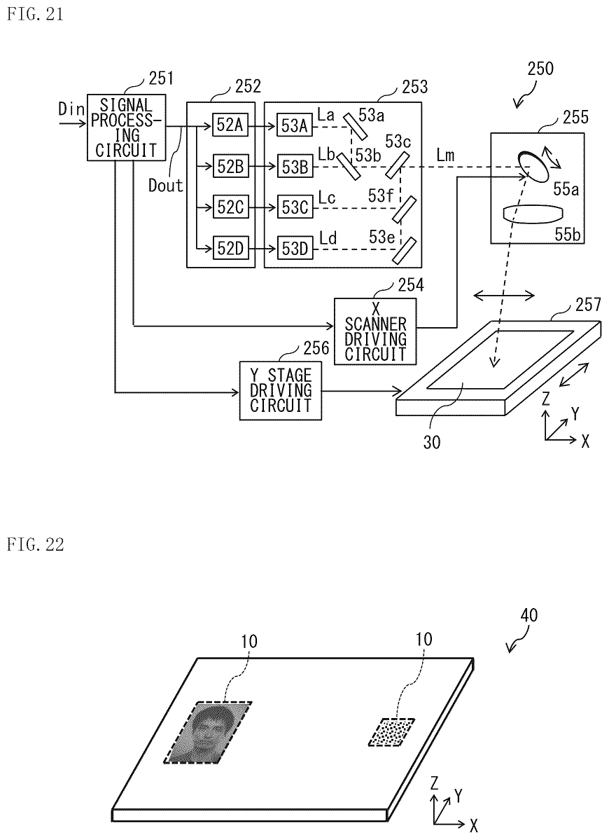

The drawing system 100 according to the present modification example includes, for example, a drawing section 250 instead of the drawing section 150 in the drawing system 100 according to the embodiment described above. For example, as illustrated in FIG. 21, the drawing section 250 includes a signal processing circuit 251, a laser driving circuit 252, a light source section 253, an X scanner driving circuit 254, an X scanner section 255, a Y stage driving circuit 256, and a Y stage 257. The drawing section 250 is configured to execute drawing on the stacked body 30 by controlling output of the light source section 253 on the basis of a voltage value file (a list of command voltage values) inputted from the information processor 160.

The signal processing circuit 251 is configured to acquire the voltage value file (the list of command voltage values) inputted from the information processor 160 as the image signal Din. The signal processing circuit 251 is configured, for example, to generate, from the image signal Din, the pixel signal Dout corresponding to a scanner operation of the X scanner section 255. The pixel signal Dout causes the light source section 253 (e.g., each of light sources 53A, 53B, 53C, and 53D to be described later) to output a laser light beam having power corresponding to the command voltage values. The signal processing circuit 251 is configured to control, together with the laser driving circuit 252, a peak value of a current to be applied to the light source section 253 (e.g., each of the light sources 53A, 53B, 53C, and 53D) depending on the pixel signal Dout.

The laser driving circuit 252 is configured, for example, to drive each of the light sources 53A, 53B, 53C, and 53D of the light source section 253 in accordance with the pixel signal Dout. The laser driving circuit 252 is configured, for example, to control luminance (brightness) of a laser light beam to draw an image corresponding to the pixel signal Dout. The laser driving circuit 252 includes, for example, the driving circuit 52A that drives the light source 53A, the driving circuit 52B that drives the light source 53B, the driving circuit 52C that drives the light source 53C, and a driving circuit 52D that drives the light source 53D.

The light sources 53A, 53B, 53C, and 53D are each configured to output a laser light beam having power corresponding to the command voltage values to the stacked body 30 to thereby execute drawing on the stacked body 30. The light sources 53A, 53B, 53C, and 53D are each configured to emit a laser light beam in the near-infrared region. The light source 53A is, for example, the semiconductor laser that emits the laser light beam La having the light emission wavelength λ1. The light source 53B is, for example, the semiconductor laser that emits the laser light beam Lb having the light emission wavelength λ2. The light source 53C is, for example, the semiconductor laser that emits the laser light beam Lc having the light emission wavelength 3. The light source 53D is, for example, an excimer laser that emits a laser light beam Ld having a light emission wavelength λ4 allowing for recording on the laser marking layers 36 and 38.

The light source section 253 includes a plurality of light sources (e.g., the four light sources 53A, 53B, 53C, and 53D) different from each other in light emission wavelength in the near-infrared region. Each of the light sources (e.g., each of the light sources 53A, 53B, 53C, and 53D) is configured, for example, to generate a laser light beam including a wavelength corresponding to a light absorption wavelength band of a photothermal conversion agent (to be described later) included in the stacked body 30. The light source section 253 further includes, for example, an optical system that combines a plurality of laser light beams (e.g., the four laser light beams La, Lb, Lc, and Ld) emitted from the plurality of light sources (e.g., the four light sources 53A, 53B, 53C, and 53D). This optical system is configured, for example, to so output a combined light beam (a laser light beam Lm) of the plurality of laser light beams La, Lb, Lc, and Ld to the X scanner section 55 that a plurality of irradiation spots Pa, Pb, Pc, and Pd generated on the stacked body 30 by the plurality of laser light beams La, Lb, Lc, and Ld overlaps with each other on the Y stage 57. That is, in the light source section 253, the optical system of the light sources 53A, 53B, and 53C including the respective semiconductor lasers having three wavelengths and the optical system of the light source 53D including the excimer laser are included in one optical system. The X-axis direction is a direction orthogonal to the movement direction (the Y-axis direction) of the Y stage 57, and is a direction parallel to a scanning direction of a one-axis scanner 55a to be described later. The light source section 253 includes, for example, two reflection mirrors 53a and 53d, and three dichroic mirrors 53b, 53c, and 53f as such an optical system.

Each of the laser light beams La and Lb emitted from the two light sources 53A and 53B is converted into substantially parallel light (collimated light) by a collimating lens, for example. Thereafter, for example, the laser light beam La is reflected by the reflection mirror 53a and further reflected by the dichroic mirror 53b, and the laser light beam Lb is transmitted through the dichroic mirror 53b. Thus, the laser light beam La and the laser light beam Lb are combined. The combined light beam of the laser light beam La and the laser light beam La is transmitted through the dichroic mirror 53c.

Each of the laser light beams Lc and Ld emitted from the light sources 53C and 53D is converted into substantially parallel light (collimated light) by a collimating lens, for example. Thereafter, for example, the laser light beam Lc is reflected by the dichroic mirror 53f and further reflected by the dichroic mirror 53c. Thus, the above-described combined light beam transmitted through the dichroic mirror 53c and the laser light beam Lc reflected by the dichroic mirror 53c are combined. For example, the laser light beam Ld is reflected by the reflection mirror 53e and transmitted through the dichroic mirror 53f, and thereafter reflected by the dichroic mirror 53c. Thus, the above-described combined light beam transmitted through the dichroic mirror 53c, the laser light beam Lc reflected by the dichroic mirror 53c, and the laser light beam Ld reflected by the dichroic mirror 53c are combined. The light source section 53 outputs, to the X scanner section 255, for example, the above-described light (the laser light beam Lm) obtained by combining performed by the optical system.

The X scanner driving circuit 254 is configured, for example, to drive the X scanner section 255 on the basis of a control signal inputted from the signal processing circuit 251. In addition, for example, in a case where a signal regarding an irradiation angle of the one-axis scanner 55a or the like is inputted from the X scanner section 255, the X scanner driving circuit 254 drives the X scanner section 255 to cause the irradiation angle to be a desired irradiation angle on the basis of the signal.

The X scanner section 255 is configured, for example, to scan the surface of the stacked body 30 in the X-axis direction with the laser light beam Lm incident from the light source section 253. The X scanner section 255 includes, for example, the one-axis scanner 55a and an fθ lens 55b. The one-axis scanner 55a is, for example, a galvanometer mirror that scans the surface of the stacked body 30 in the X-axis direction with the laser light beam Lx incident from the light source section 253 on the basis of a drive signal inputted from the X scanner driving circuit 254. The fθ lens 55b is configured to convert a constant speed rotational motion by the one-axis scanner 55a into a constant speed linear motion of a spot moving on a focal plane (the surface of the stacked body 30).

The Y stage driving circuit 256 is configured, for example, to drive the Y stage 257 on the basis of a control signal inputted from the signal processing circuit 251. The Y stage 257 is configured to move the stacked body 30 placed on the Y stage 257 with respect to the X scanner section 255 in the Y-axis direction at a predetermined speed by displacing the Y stage 257 in the Y-axis direction at a predetermined speed. The surface of the stacked body 30 is raster-scanned with the laser light beam Lm by a cooperative operation of the X scanner section 255 and the Y stage 257.

Next, a description is given of an example of writing of information in the drawing system 100 according to the present modification example.

First, the user prepares the color-undeveloped stacked body 30 and places the stacked body 30 on the Y stage 257. Next, the user sends input image data described in the RGB color space from the terminal device to the drawing system 100 via the network. Upon receiving the input image data via the network, the drawing system 100 performs the following drawing process.

First, upon receiving the input image data via the communication section 110, the information processor 160 converts the input image data described in the RGB color space into leuco image data described in the leuco color space and monochrome image data described in a black or dark color space. Thereafter, the information processor 160 derives a voltage value file (a list of command voltage values) on the basis of gradation values of respective colors of each drawing coordinate of the leuco image data and the monochrome image data obtained by the conversion. The information processor 160 transmits the derived voltage value file (the list of command voltage values) to the drawing section 250.

The signal processing circuit 251 of the drawing section 250 acquires, as the image signal Din, the voltage value file (the list of command voltage values) inputted from the information processor 160. The signal processing circuit 251 generates, from the image signal Din, an image signal corresponding to characteristics such as the wavelength of a laser light beam in synchronization with a scanner operation of the X scanner section 255. The signal processing circuit 251 converts, in the generated image signal, an image signal for one line corresponding to one time of the scanner operation into a continuous signal for continuously outputting the laser light beam over time. The signal processing circuit 251 outputs the thus generated projection image signal to the laser driving circuit 252 of the drawing section 250. The projection image signal is a signal for causing each of the light sources 53A, 53B, 53C, and 53D to continuously output the laser light beam for one line over time, and is not a signal for causing each of the light sources 53A, 53B, 53C, and 53D to discontinuously outputting the laser light beam for one line.

The laser driving circuit 252 drives the light sources 53A, 53B, 53C, and 53D of the light source section 253 in accordance with projection image signals corresponding to the respective wavelengths. In this case, the laser driving circuit 252 causes a laser light beam to be emitted from at least one light source out of the light source 53A, the light source 53B, the light source 53C, and the light source 53D, for example, and to scan the stacked body 30.

For example, in a case of causing the recording layer 13 to develop a color, the recording layer 13 is irradiated with the laser light beam La having the light emission wavelength λ1 with such energy that the recording layer 13 reaches a color-developing temperature. Accordingly, the photothermal conversion agent included in the recording layer 13 generates heat to cause a color reaction (a color-developing reaction) between the coloring compound and the color developing/reducing agent, thereby developing, for example, a magenta color in an irradiated portion. Likewise, in a case of causing the recording layer 15 to develop a color, the recording layer 15 is irradiated with the laser light beam Lb having the light emission wavelength λ2 with such energy that the recording layer 15 reaches a color-developing temperature to develop, for example, a cyan color in an irradiated portion. In a case of causing the recording layer 17 to develop a color, the recording layer 17 is irradiated with the laser light beam Lc having the light emission wavelength λ3 with such energy that the recording layer 17 reaches a color-developing temperature to develop, for example, a yellow color in an irradiated portion. Thus, irradiating any portion with a laser light beam having a corresponding wavelength makes it possible to record a figure or the like (e.g., a full-color figure or the like).

Likewise, in a case of causing the laser marking layer 36 or 38 to develop a color, the laser marking layer 36 or 38 is irradiated with the laser light beam Ld having the light emission wavelength λ4 with such energy that the laser marking layer 36 or 38 reaches a color-developing temperature to develop, for example, a black color or a dark color in an irradiated portion. Thus, irradiating any portion with a laser light beam having a corresponding wavelength makes it possible to record a figure or the like (e.g., a full-color figure or the like).

A mechanism including the X scanner driving circuit 254, the X scanner section 255, the Y stage driving circuit 256, and the Y stage 257 functions as a scanning section that irradiates the surface of the stacked body 30 with the laser light beam Lm generated by the light source section 253. The irradiation spot of the laser light beam Lm preferably has such a size and a shape that a high-temperature region generated in and around the recording layer 13 by the laser light beam La included in the laser light beam Lm and a high-temperature region generated in and around the recording layer 15 by the laser light beam Lb included in the laser light beam Lm do not overlap with each other. In addition, the irradiation spot of the laser light beam Lm preferably has such a size and a shape that the high-temperature region generated in and around the recording layer 15 by the laser light beam Lb included in the laser light beam Lm and a high-temperature region generated in and around the recording layer 17 by the laser light beam Lc included in the laser light beam Lm do not overlap with each other.

In addition, the irradiation spot of the laser light beam Lm preferably has such a size and a shape that the high-temperature region generated in and around the recording layer 17 by the laser light beam Lc included in the laser light beam Lm and a high-temperature region generated in and around the laser marking layer 38 by the laser light beam Ld included in the laser light beam Lm do not overlap with each other. In addition, the irradiation spot of the laser light beam Lm preferably has such a size and a shape that the high-temperature region generated in and around the recording layer 13 by the laser light beam La included in the laser light beam Lm and a high-temperature region generated in and around the laser marking layer 36 by the laser light beam Ld included in the laser light beam Lm do not overlap with each other.

FIG. 22 illustrates an example of a drawing object 40 formed by irradiating the stacked body 30 including the one or the plurality of recording media 10 with the laser light beam Lm. The image 20A, of the drawing object 40, formed by the irradiation with the laser light beam Lm is visually recognizable on the surface of the recording medium 10. The image 20A is formed by continuously irradiating the recording layers 13, 15, and 17 of the recording medium 10 and the laser marking layer 36 or the laser marking layer 38 with the laser light beam Lm in the scanning direction. The image 20A is formed at a position at a predetermined depth from the surface of the recording medium 10. The image 20A includes, for example, the features described in FIG. 8, FIG. 9, (A) of FIG. 10, and (B) of FIG. 10.

Next, a description is given of an example of a method of forming the drawing object 40 by the drawing system 100. First, the user prepares the stacked body 30 that has not been processed yet (that has not been subjected to drawing yet), and places the stacked body 30 on the Y stage 257. Thereafter, the user instructs the drawing system 100 to perform drawing on the stacked body 30. In response thereto, the drawing system 100 continuously irradiates the stacked body 30 with the laser light beam Lm to form, as the drawing mark, the striped pattern extending in the X direction and having the irregular widths on each of the plurality of heat-sensitive recording layers (the recording layers 13, 15, and 17 and the laser marking layer 36 or the laser marking layer 38). At this time, the drawing system 100 temporarily stops the irradiation with the laser light beam Lm each time the irradiation with the laser light beam Lm for one line is finished, and moves the Y stage 257 in the Y direction by a predetermined amount to allow for the irradiation with the laser light beam Lm for the next line. Upon finishing moving the Y stage 257, the drawing system 100 continuously irradiates the stacked body 30 with the laser light beam Lm again.

For example, in the drawing process described above, the drawing system 100 draws the striped pattern 21a on each of the plurality of heat-sensitive recording layers (the recording layers 13, 15, and 17 and the laser marking layer 36 or the laser marking layer 38) to allow, in the spatial frequency spectrum of the image data 21 obtained by performing the imaging with the use of the ring illumination, the spatial frequency profile in the Y direction to include the cyclical peaks Py not included in the spatial frequency profile in the X direction. For example, the drawing system 100 draws the striped pattern 21a on each of the plurality of heat-sensitive recording layers (the recording layers 13, 15, and 17 and the laser marking layer 36 or the laser marking layer 38) to allow the intensity ratio at the position of one of the peaks Py to satisfy the above-described expression (S2/S1≥1.2) when the spatial frequency profile in the X direction and the spatial frequency profile in the Y direction are overlapped with each other. For example, the drawing system 100 draws the striped pattern 21a on each of the plurality of heat-sensitive recording layers (the recording layers 13, 15, and 17 and the laser marking layer 36 or the laser marking layer 38) to allow the X direction to be a direction parallel to one end side of the recording medium 10 and the Y direction to be a direction parallel to another end side orthogonal to the foregoing end side of the recording medium 10. The drawing object 40 is formed in the above-described manner.

In the present modification example, the laser marking layer 36 or 38 is provided in addition to the recording layers 13, 15, and 17. This allows for color development of a black color or a dark color by the laser marking layer 36 or 38, which makes it possible to achieve display with high contrast as compared with full-color display by the recording layers 13, 15, and 17.

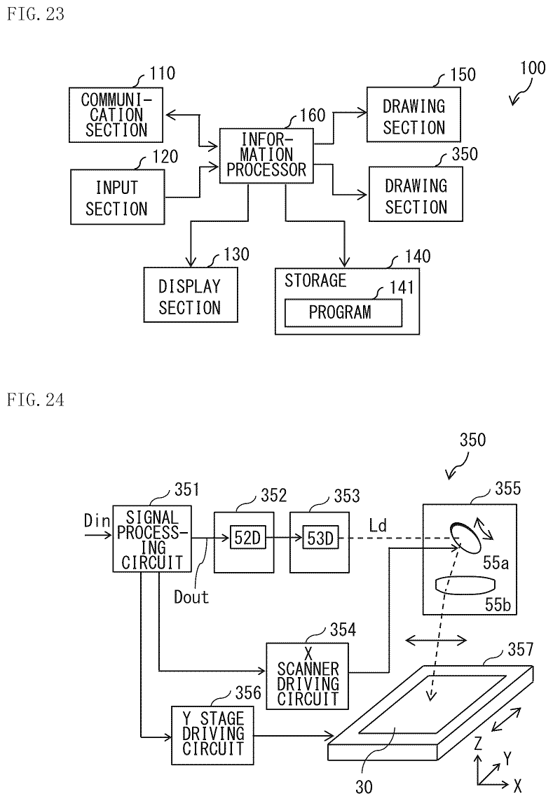

In the present modification example, for example, a drawing section 350 illustrated in FIG. 23 may be used as the drawing section configured to perform laser drawing on the laser marking layer 36 or 38. In this case, the laser drawing on the recording layers 13, 15, and 17 may be performed by the drawing section 150, and the laser drawing on the laser marking layer 36 or 38 may be performed by the drawing section 350. That is, in the present modification example, the optical system for performing the laser drawing on the recording layers 13, 15, and 17 and the optical system for performing the laser drawing on the laser marking layer 36 or 38 are provided separately from each other.

For example, as illustrated in FIG. 24, the drawing section 350 includes a signal processing circuit 351, a laser driving circuit 352, alight source section 353, an X scanner driving circuit 354, an X scanner section 355, a Y stage driving circuit 356, and a Y stage 357. The drawing section 350 is configured to execute drawing on the stacked body 30 by controlling output of the light source section 353 on the basis of a voltage value file (a list of command voltage values) inputted from the information processor 160.

The signal processing circuit 351 is configured to acquire, as the image signal Din, the voltage value file (the list of command voltage values) inputted from the information processor 160. The signal processing circuit 351 is configured, for example, to generate, from the image signal Din, the pixel signal Dout corresponding to a scanner operation of the X scanner section 355. The pixel signal Dout causes the light source section 353 (e.g., the light source 53D to be described later) to output a laser light beam having power corresponding to the command voltage values. The signal processing circuit 351 is configured to control, together with the laser driving circuit 352, a peak value of a current to be applied to the light source section 353 (e.g., the light source 53D) depending on the pixel signal Dout.

The laser driving circuit 352 is configured, for example, to drive the light source 53D of the light source section 353 in accordance with the pixel signal Dout. The laser driving circuit 352 is configured, for example, to control luminance (brightness) of a laser light beam to draw an image corresponding to the pixel signal Dout. The laser driving circuit 352 includes, for example, the driving circuit 52D that drives the light source 53D.

The light source 53D is configured to output a laser light beam having power corresponding to the command voltage values to the stacked body 30 to thereby execute drawing on the stacked body 30. The light source 53D is configured to emit a laser light beam in the near-infrared region. The light source 53D is, for example, an excimer laser that emits the laser light beam Ld having the light emission wavelength λ4 allowing for recording on the laser marking layers 36 and 38.

The light source section 353 includes the light source 53D. The laser light beam Ld emitted from the light source 53D is converted into substantially parallel light (collimated light) by a collimating lens, for example. The light source section 353 is configured to output the laser light beam Ld converted into the substantially parallel light to the X scanner section 355.

The X scanner driving circuit 354 is configured, for example, to drive the X scanner section 355 on the basis of a control signal inputted from the signal processing circuit 351. In addition, in a case where a signal regarding an irradiation angle of the one-axis scanner 55a or the like is inputted from the X scanner section 355, the scanner driving circuit 354 is configured to drive the X scanner section 355 to cause the irradiation angle to be a desired irradiation angle on the basis of the signal.

For example, the X scanner section 355 is configured, for example, to scan the surface of the stacked body 30 in the X-axis direction with the laser light beam Ld incident from the light source section 353. The X scanner section 355 includes, for example, the one-axis scanner 55a and the fθ lens 55b. The one-axis scanner 55a is, for example, a galvanometer mirror that scans the surface of the stacked body 30 in the X-axis direction with the laser light beam Ld incident from the light source section 353 on the basis of a drive signal inputted from the X scanner driving circuit 354. The fθ lens 55b is configured to convert a constant speed rotational motion by the one-axis scanner 55a into a constant speed linear motion of a spot moving on a focal plane (the surface of the stacked body 30).

The Y stage driving circuit 356 is configured, for example, to drive the Y stage 357 on the basis of a control signal inputted from the signal processing circuit 351. The Y stage 357 is configured to move the stacked body 30 placed on the Y stage 357 with respect to the X scanner section 355 in the Y-axis direction at a predetermined speed by displacing the Y stage 357 in the Y-axis direction at a predetermined speed. The surface of the stacked body 30 is raster-scanned with the laser light beam Ld by a cooperative operation of the X scanner section 355 and the Y stage 357.

Next, a description is given of an example of writing of information in the drawing system 100 according to the present modification example.

First, the user prepares the color-undeveloped stacked body 30 and places the stacked body 30 on the Y stage 157 of the drawing section 150. Next, the user sends input image data described in the RGB color space from the terminal device to the drawing system 100 via the network. Upon receiving the input image data via the network, the drawing system 100 performs the following drawing process.

First, upon receiving the input image data via the communication section 110, the information processor 160 converts the input image data described in the RGB color space into leuco image data described in the leuco color space and monochrome image data described in a black or dark color space. Thereafter, the information processor 160 derives a voltage value file (a list of command voltage values) on the basis of gradation values of respective colors of each drawing coordinate of the leuco image data and the monochrome image data obtained by the conversion. The information processor 160 transmits, to the drawing section 150, the voltage value file (the list of command voltage values) derived on the basis of the gradation values of the respective colors of each drawing coordinate of the leuco image data. The information processor 160 further transmits, to the drawing section 250, the voltage value file (the list of command voltage values) derived on the basis of the gradation values of the respective colors of each drawing coordinate of the monochrome image data.

The signal processing circuit 151 of the drawing section 150 acquires, as the image signal Din, the voltage value file (the list of command voltage values) inputted from the information processor 160. The signal processing circuit 151 generates, from the image signal Din, an image signal corresponding to characteristics such as the wavelength of the laser light beam in synchronization with a scanner operation of the X scanner section 155. The signal processing circuit 151 converts, in the generated image signal, an image signal for one line corresponding to one time of the scanner operation into a continuous signal for continuously outputting the laser light beam over time. The signal processing circuit 151 outputs the thus generated projection image signal to the laser driving circuit 152 of the drawing section 150. The projection image signal is a signal for causing each of the light sources 53A, 53B, and 53C to continuously output the laser light beam for one line over time, and is not a signal for causing each of the light sources 53A, 53B, and 53C to discontinuously output the laser light beam for one line.

The laser driving circuit 152 drives the light sources 53A, 53B, and 53C of the light source section 153 in accordance with projection image signals corresponding to the respective wavelengths. In this case, the laser driving circuit 152 causes a laser light beam to be emitted from at least one light source out of the light source 53A, the light source 53B, and the light source 53C, for example, and to scan the stacked body 30.

For example, in a case of causing the recording layer 13 to develop a color, the recording layer 13 is irradiated with the laser light beam La having the light emission wavelength λ1 with such energy that the recording layer 13 reaches a color-developing temperature. Accordingly, the photothermal conversion agent included in the recording layer 13 generates heat to cause a color reaction (a color-developing reaction) between the coloring compound and the color developing/reducing agent, thereby developing, for example, a magenta color in an irradiated portion. Likewise, in a case of causing the recording layer 15 to develop a color, the recording layer 15 is irradiated with the laser light beam Lb having the light emission wavelength λ2 with such energy that the recording layer 15 reaches a color-developing temperature to develop, for example, a cyan color in an irradiated portion. In a case of causing the recording layer 17 to develop a color, the recording layer 17 is irradiated with the laser light beam Lc having the light emission wavelength λ3 with such energy that the recording layer 17 reaches a color-developing temperature to develop, for example, a yellow color in an irradiated portion. Thus, irradiating any portion with a laser light beam having a corresponding wavelength makes it possible to record a figure or the like (e.g., a full-color figure or the like).

A mechanism including the X scanner driving circuit 154, the X scanner section 155, the Y stage driving circuit 156, and the Y stage 157 functions as a scanning section that irradiates the surface of the stacked body 30 with the laser light beam Lm generated by the light source section 153. The irradiation spot of the laser light beam Lm preferably has such a size and a shape that a high-temperature region generated in and around the recording layer 13 by the laser light beam La included in the laser light beam Lm and a high-temperature region generated in and around the recording layer 15 by the laser light beam Lb included in the laser light beam Lm do not overlap with each other. In addition, the irradiation spot of the laser light beam Lm preferably has such a size and a shape that the high-temperature region generated in and around the recording layer 15 by the laser light beam Lb included in the laser light beam Lm and a high-temperature region generated in and around the recording layer 17 by the laser light beam Lc included in the laser light beam Lm do not overlap with each other.

Thereafter, the user places the stacked body 30 on which the drawing has been performed by the drawing section 150, on the Y stage 357 of the drawing section 350. In this case, coordinates of the Y stage 357 of the drawing section 150 and coordinates of the Y stage 357 of the drawing section 350 are preferably associated with each other. Further, reference coordinates of the drawing section 150 and reference coordinates of the drawing section 350 are preferably associated with each other.

Thereafter, the signal processing circuit 351 of the drawing section 350 acquires, as the image signal Din, the voltage value file (the list of command voltage values) inputted from the information processor 160. The signal processing circuit 351 generates, from the image signal Din, an image signal corresponding to characteristics such as the wavelength of the laser light beam in synchronization with a scanner operation of the X scanner section 355. The signal processing circuit 351 converts, in the generated image signal, an image signal for one line corresponding to one time of the scanner operation into a continuous signal for continuously outputting the laser light beam over time. The signal processing circuit 251 outputs the thus generated projection image signal to the laser driving circuit 352 of the drawing section 350. The projection image signal is a signal for causing the light source 53D to continuously output the laser light beam for one line over time, and is not a signal for causing the light source 53D to discontinuously output the laser light beam for one line.

The laser driving circuit 352 drives the light source 53D of the light source section 353 in accordance with a projection image signal corresponding to the wavelength. In this case, the laser driving circuit 352 causes a laser light beam to be emitted from the light source 53D, for example, and to scan the stacked body 30.

For example, the laser marking layer 36 or 38 is irradiated with the laser light beam Ld having the light emission wavelength λ4 with such energy that the laser marking layer 36 or 38 reaches a color-developing temperature to develop, for example, a black color or a dark color in an irradiated portion. Thus, irradiating any portion with a laser light beam having a corresponding wavelength makes it possible to record a figure or the like (e.g., a full-color figure or the like).

A mechanism including the X scanner driving circuit 354, the X scanner section 355, the Y stage driving circuit 356, and the Y stage 357 functions as a scanning section that irradiates the surface of the stacked body 30 with the laser light beam Ld generated by the light source section 353. The irradiation spot of the laser light beam Ld preferably has such a size and a shape that a high-temperature region generated in and around the laser marking layer 38 by the laser light beam Ld and the recording layer 17 do not overlap with each other. In addition, it is preferable that a high-temperature region generated in and around the laser marking layer 36 by the laser light beam Ld included in the laser light beam Lm and the recording layer 13 do not overlap with each other.

The description has been given of the example in which the laser drawing is performed on the recording layers 13, 15, and 17, and thereafter, the laser drawing is performed on the laser marking layer 36 or 38; however, the order of performing the laser drawing is not limited to this order. For example, the laser drawing may be performed on the laser marking layer 36 or 38, and thereafter, the drawing laser drawing may be performed on the recording layers 13, 15, and 17.

### Modification Example E

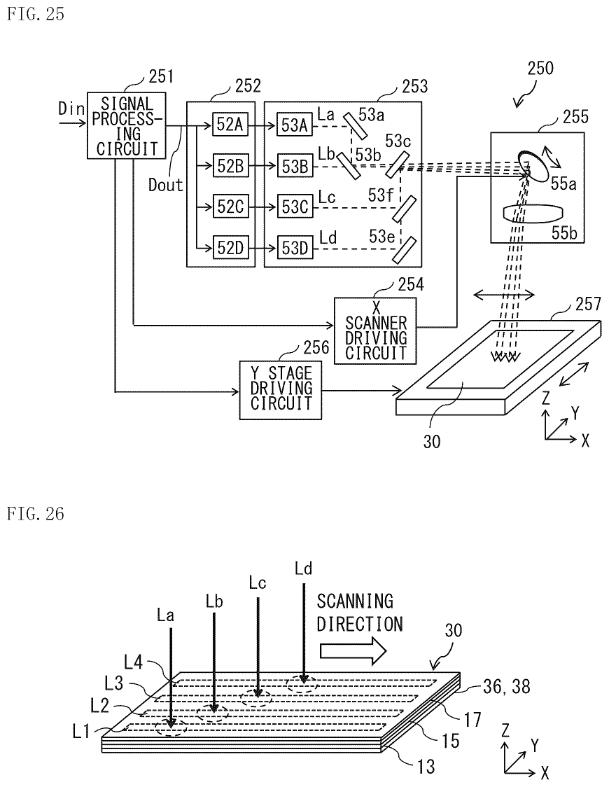

In the modification example D described above, the light source section 253 of the drawing section 250 may be configured, for example, as illustrated in FIG. 25, to so generate the plurality of laser light beams La, Lb, and Lc that the surface of the stacked body 30 is scanned with the plurality of laser light beams La, Lb, Lc, and Ld in a state where the illumination spots formed by the plurality of laser light beams La, Lb, Lc, and Ld are arranged side by side at predetermined intervals in a direction intersecting with the scanning directions of the plurality of laser light beams La, Lb, Lc, and Ld at an angle greater than 0° and less than 90°. For example, as illustrated in FIG. 26, scanning may be performed in the X-axis direction while the laser light beams La, Lb, Lc, and Ld have predetermined intervals in a direction obliquely intersecting with the X-axis direction and the Y-axis direction. For example, the scanning may be performed in the X-axis direction while the laser light beams La, Lb, Lc, and Ld have predetermined intervals in a direction (the Y-axis direction) orthogonal to the X-axis direction.

Here, on the dichroic mirror 53b, a spot where the laser light beam La is reflected and a spot where the laser light beam Lb is transmitted may overlap with each other. In this case, the optical system is configured to cause an optical axis of the laser light beam La reflected by the dichroic mirror 53b and an optical axis of the laser light beam Lb transmitted through the dichroic mirror 53b to intersect with each other at a predetermined angle.

Alternatively, on the dichroic mirror 53b, the spot where the laser light beam La is reflected and the spot where the laser light beam Lb is transmitted may not completely overlap with each other and may be shifted from each other. Alternatively, on the dichroic mirror 53b, the spot where the laser light beam La is reflected and the spot where the laser light beam Lb is transmitted may be separated from each other. In these cases, the optical system may be configured to cause the optical axis of the laser light beam La reflected by the dichroic mirror 53b and the optical axis of the laser light beam Lb transmitted through the dichroic mirror 53b to intersect with each other at a predetermined angle, or the optical system may be configured to cause the optical axis of the laser light beam La reflected by the dichroic mirror 53b and the optical axis of the laser light beam Lb transmitted through the dichroic mirror 53b to be parallel to each other.

The optical system is configured to cause a spot where the laser light beam La or the laser light beam Lb is transmitted and a spot where the laser light beam Lc or the laser light beam Ld is reflected to be shifted from each other on the dichroic mirror 53c without completely overlapping with each other. In this case, on the dichroic mirror 53c, the spot where the laser light beam La is transmitted, the spot where the laser light beam Lb is transmitted, the spot where the laser light beam Lc is reflected, and the spot where the laser light beam Ld is reflected may be arranged side by side in a predetermined direction while being slightly shifted from each other. On the dichroic mirror 53c, the spot where the laser light beam La is transmitted, the spot where the laser light beam Lb is transmitted, the spot where the laser light beam Lc is reflected, and the spot where the laser light beam Ld is reflected may be arranged side by side at predetermined intervals.

In these cases, the optical system may be configured to cause the optical axis of the laser light beam La transmitted through the dichroic mirror 53c, the optical axis of the laser light beam Lb transmitted through the dichroic mirror 53c, the optical axis of the laser light beam Lc reflected by the dichroic mirror 53c, and the optical axis of the laser light beam Ld reflected by the dichroic mirror 53c to intersect with each other at a predetermined angle. In this case, the light source section 253 outputs the plurality of laser light beams La, Lb, Lc, and Ld to the X scanner section 255 in a state where the optical axes of the plurality of laser light beams La, Lb, Lc, and Ld are shifted from each other, and outputs the plurality of laser light beams La, Lb, Lc, and Ld to the X scanner section 255 to cause the optical axes of the plurality of laser light beams La, Lb, Lc, and Ld to intersect with each other at a predetermined angle.

Alternatively, the optical system may be configured to cause the optical axis of the laser light beam La transmitted through the dichroic mirror 53c, the optical axis of the laser light beam Lb transmitted through the dichroic mirror 53c, the optical axis of the laser light beam Lc reflected by the dichroic mirror 53c, and the optical axis of the laser light beam Ld reflected by the dichroic mirror 53c to be parallel to each other. In this case, the light source section 253 outputs the plurality of laser light beams La, Lb, Lc, and Ld to the X scanner section 255 in a state where the optical axes of the plurality of laser light beams La, Lb, Lc, and Ld are shifted from each other, and outputs the plurality of laser light beams La, Lb, Lc, and Ld to the X scanner section 255 to cause the optical axes of the plurality of laser light beams La, Lb, Lc, and Ld to be parallel to each other at predetermined intervals.

In the present modification example, the surface of the stacked body 30 is scanned with the plurality of laser light beams La, Lb, Lc, and Ld in the state where the irradiation spots of the plurality of laser light beams La, Lb, Lc, and Ld are arranged side by side at the predetermined intervals in the direction intersecting with the scanning directions of the plurality of laser light beams La, Lb, Lc, and Ld. This makes it possible to perform raster-scanning while reducing occurrence of thermal crosstalk.

In the present modification example, an X scanner configured to scan the surface of the stacked body 30 in the X-axis direction with the laser light beam Ld incident from the light source section 25D may be provided separately from the X scanner section 255. In this case, as the X scanner for the laser light beam Ld, for example, a one-axis scanner and an fθ lens may be provided. Here, the one-axis scanner for the laser light beam Ld is, for example, a galvanometer mirror that scans the surface of the stacked body 30 in the X-axis direction with the laser light beam Ld incident from the light source section 25D on the basis of a drive signal inputted from the X scanner driving circuit 254. The fθ lens for the laser light beam Ld is configured, for example, to convert a constant speed rotational motion by the one-axis scanner for the laser light beam Ld into a constant speed linear motion of a spot moving on a focal plane (the surface of the stacked body 30). Even in such a case, it is possible to perform raster-scanning with the plurality of laser light beams La, Lb, Lc, and Ld.

It is to be noted that the effects described herein are mere examples. Effects of the present disclosure are not limited to those described herein. The present disclosure may further have any effects other than those described herein.

In addition, the present disclosure may have the following configurations, for example.

(1)

A drawing object including
a stacked body including a plurality of first heat-sensitive recording layers stacked with a heat-insulating layer interposed between the plurality of first heat-sensitive recording layers, the plurality of first heat-sensitive recording layers being different from each other in color in a color-developed state and light absorption wavelength band, wherein
the respective first heat-sensitive recording layers include coloring compounds and matrix resins, the coloring compounds being different from each other in the color in the color-developed state, the respective matrix resins allowing the coloring compounds to be dispersed, and
the plurality of first heat-sensitive recording layers each has a striped pattern drawn as a drawing mark resulting from irradiating a surface of the stacked body with a laser light beam, the striped pattern extending in a first direction and having irregular widths.
   (2)

The drawing object according to (1), further including a second heat-sensitive recording layer different from each of the first heat-sensitive recording layers in recording method.

(3)

The drawing object according to (1) or (2), wherein the striped pattern is drawn on each of the plurality of first heat-sensitive recording layers in a state where, in a spatial frequency spectrum of image data obtained by performing imaging of the striped pattern with use of ring illumination, a profile in a second direction includes cyclical peaks not included in a profile in the first direction, the second direction being orthogonal to the first direction.

(4)

The drawing object according to (3), in which an intensity ratio at a position of one of the peaks when the profile in the first direction and the profile in the second direction are overlapped with each other satisfies the following expression,

S2/S1≥1.2
where
S1 is an intensity, of the profile in the first direction, at the position of the one of the peaks, and
S2 is an intensity, of the profile in the second direction, at the position of the one of the peaks.
   (5)

The drawing object according to (3) or (4), in which
the stacked body includes a sheet-shaped or plate-shaped stacked body having a quadrangular shape in plan view,
the first direction includes a direction parallel to a first end side of the stacked body, and
the second direction includes a direction parallel to a second end side of the stacked body, the second end side being orthogonal to the first end side.
   (6)

The drawing object according to (3) or (4), in which
the stacked body includes a sheet-shaped or plate-shaped stacked body having a quadrangular shape in plan view, and
the first direction and the second direction each include a direction obliquely intersecting with all end sides of the stacked body.
   (7)

The drawing object according to any one of (1) to (6), in which the respective first heat-sensitive recording layers include photothermal conversion agents different from each other in the light absorption wavelength band.

(8)

The drawing object according to any one of (1) to (7), in which the plurality of first heat-sensitive recording layers each has the striped pattern drawn as the drawing mark resulting from continuously irradiating the surface of the stacked body with the laser light beam in a scanning direction, the striped pattern extending in the first direction and having the irregular widths.

(9)

A method of forming a drawing object, the method including:
preparing a drawing object including a stacked body including a plurality of first heat-sensitive recording layers stacked with a heat-insulating layer interposed between the plurality of first heat-sensitive recording layers, the plurality of first heat-sensitive recording layers being different from each other in color in a color-developed state and light absorption wavelength band, the respective first heat-sensitive recording layers including coloring compounds and matrix resins, the coloring compounds being different from each other in the color in the color-developed state, the respective matrix resins allowing the coloring compounds to be dispersed; and
forming, as a drawing mark, a first striped pattern on each of the plurality of first heat-sensitive recording layers by irradiating the plurality of first heat-sensitive recording layers with a first laser light beam, the first striped pattern extending in a first direction and having irregular widths.
   (10)

The method of forming a drawing object according to (9), in which
the drawing object further includes a second heat-sensitive recording layer different from each of the first heat-sensitive recording layers in recording method, and
the method includes forming a second striped pattern on the second heat-sensitive recording layer by a recording method different from a recording method of each of the first heat-sensitive recording layers by irradiating the second heat-sensitive recording layer with a second laser light beam.
   (11)

The method of forming a drawing object according to (9) or (10), including drawing the first striped pattern on each of the plurality of first heat-sensitive recording layers to allow, in a spatial frequency spectrum of image data obtained by performing imaging of the first striped pattern with use of ring illumination, a profile in a second direction to include cyclical peaks not included in a profile in the first direction, the second direction being orthogonal to the first direction.

(12)

The method of forming a drawing object according to (9) or (10), including drawing the first striped pattern on each of the plurality of first heat-sensitive recording layers to allow an intensity ratio at a position of one of the peaks when the profile in the first direction and the profile in the second direction are overlapped with each other to satisfy the following expression,

S2/S1≥1.2
where
S1 is an intensity, of the profile in the first direction, at the position of the one of the peaks, and
S2 is an intensity, of the profile in the second direction, at the position of the one of the peaks.
   (13)

The method of forming a drawing object according to any one of (9) to (12), including
drawing the first striped pattern on each of the plurality of first heat-sensitive recording layers to allow the first direction to be a direction parallel to a first end side of the stacked body and allow the second direction to be a direction parallel to a second end side of the stacked body, the second end side being orthogonal to the first end side, in which
the stacked body includes a sheet-shaped or plate-shaped stacked body having a quadrangular shape in plan view.
   (14)

The method of forming a drawing object according to any one of (9) to (12), including
drawing the first striped pattern on each of the plurality of first heat-sensitive recording layers to allow each of the first direction and the second direction to be a direction obliquely intersecting with all end sides of the stacked body, in which
the stacked body includes a sheet-shaped or plate-shaped stacked body having a quadrangular shape in plan view.
   (15)

The method of forming a drawing object according to any one of (9) to (14), including
forming the first striped pattern on each of the plurality of first heat-sensitive recording layers as the drawing mark by irradiating the plurality of first heat-sensitive recording layers with the first laser light beam to cause photothermal conversion agents to generate heat and thereby cause the coloring compounds to develop colors, in which
the respective first heat-sensitive recording layers include the photothermal conversion agents different from each other in the light absorption wavelength band.
   (16)

The method of forming a drawing object according to any one of (9) to (15), including continuously irradiating the plurality of first heat-sensitive recording layers with the first laser light beam in a scanning direction.

(17)

A drawing object including
a stacked body including a plurality of heat-sensitive recording layers stacked with a heat-insulating layer interposed between the plurality of heat-sensitive recording layers, the plurality of heat-sensitive recording layers being different from each other in color in a color-developed state and light absorption wavelength band, in which
the plurality of heat-sensitive recording layers each has a striped pattern drawn as a drawing mark resulting from irradiating a surface of the stacked body with a laser light beam, the striped pattern extending in a first direction and having irregular widths.
   (18)

A method of forming a drawing object, the method including:
preparing a drawing object including a stacked body including a plurality of heat-sensitive recording layers stacked with a heat-insulating layer interposed between the plurality of heat-sensitive recording layers, the plurality of heat-sensitive recording layers being different from each other in color in a color-developed state and light absorption wavelength band; and
forming the drawing object by irradiating the stacked body with a laser light beam to form, as a drawing mark, a striped pattern on each of the plurality of heat-sensitive recording layers, the striped pattern extending in a first direction and having irregular widths.
   (19)

A drawing system for a drawing object including a stacked body and a second heat-sensitive recording layer, the stacked body including a plurality of first heat-sensitive recording layers stacked with a heat-insulating layer interposed between the plurality of first heat-sensitive recording layers, the plurality of first heat-sensitive recording layers being different from each other in color in a color-developed state and light absorption wavelength band, the second heat-sensitive recording layer being different from each of the first heat-sensitive recording layers in recording method, the drawing system including:
a first light source configured to generate a first laser light beam including a first wavelength corresponding to the light absorption wavelength band of each of the first heat-sensitive recording layers;
a second light source configured to generate a second laser light beam including a second wavelength allowing for recording on the second heat-sensitive recording layer;
a first optical system that guides the first laser light to the stacked body, the first laser light being emitted from the first light source; and
a second optical system that guides the second laser light to the second heat-sensitive recording layer, the second laser light being emitted from the second light source.
   (20)

The drawing system according to (19), in which the first optical system and the second optical system are included in one optical system.

(21)

The drawing system according to (19), in which the first optical system and the second optical system are provided separately from each other.

The present application claims the benefit of Japanese Priority Patent Application JP2022-042855 filed with the Japan Patent Office on Mar. 17, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A drawing object, comprising
a stacked body including a plurality of first heat-sensitive recording layers stacked with a heat-insulating layer interposed between the plurality of first heat-sensitive recording layers, the plurality of first heat-sensitive recording layers being different from each other in color in a color-developed state and light absorption wavelength band, wherein
the respective first heat-sensitive recording layers include coloring compounds and matrix resins, the coloring compounds being different from each other in the color in the color-developed state, the respective matrix resins allowing the coloring compounds to be dispersed, and
the plurality of first heat-sensitive recording layers each has a striped pattern drawn as a drawing mark resulting from irradiating a surface of the stacked body with a laser light beam, the striped pattern extending in a first direction and having irregular widths.

2. The drawing object according to claim 1, further comprising a second heat-sensitive recording layer different from each of the first heat-sensitive recording layers in recording method.

3. The drawing object according to claim 1, wherein the striped pattern is drawn on each of the plurality of first heat-sensitive recording layers in a state where, in a spatial frequency spectrum of image data obtained by performing imaging of the striped pattern with use of ring illumination, a profile in a second direction includes cyclical peaks not included in a profile in the first direction, the second direction being orthogonal to the first direction.

4. The drawing object according to claim 3, wherein an intensity ratio at a position of one of the peaks when the profile in the first direction and the profile in the second direction are overlapped with each other satisfies the following expression,
S2/S1≥1.2
where
S1 is an intensity, of the profile in the first direction, at the position of the one of the peaks, and
S2 is an intensity, of the profile in the second direction, at the position of the one of the peaks.

5. The drawing object according to claim 3, wherein
the stacked body comprises a sheet-shaped or plate-shaped stacked body having a quadrangular shape in plan view,
the first direction comprises a direction parallel to a first end side of the stacked body, and
the second direction comprises a direction parallel to a second end side of the stacked body, the second end side being orthogonal to the first end side.

6. The drawing object according to claim 3, wherein the stacked body comprises a sheet-shaped or plate-shaped stacked body having a quadrangular shape in plan view, and
the first direction and the second direction each comprise a direction obliquely intersecting with all end sides of the stacked body.

7. The drawing object according to claim 1, wherein the respective first heat-sensitive recording layers include photothermal conversion agents different from each other in the light absorption wavelength band.

8. The drawing object according to claim 1, wherein the plurality of first heat-sensitive recording layers each has the striped pattern drawn as the drawing mark resulting from continuously irradiating the surface of the stacked body with the laser light beam in a scanning direction, the striped pattern extending in the first direction and having the irregular widths.

9. A method of forming a drawing object, the method comprising:
preparing a drawing object including a stacked body including a plurality of first heat-sensitive recording layers stacked with a heat-insulating layer interposed between the plurality of first heat-sensitive recording layers, the plurality of first heat-sensitive recording layers being different from each other in color in a color-developed state and light absorption wavelength band, the respective first heat-sensitive recording layers including coloring compounds and matrix resins, the coloring compounds being different from each other in the color in the color-developed state, the respective matrix resins allowing the coloring compounds to be dispersed; and
forming, as a drawing mark, a first striped pattern on each of the plurality of first heat-sensitive recording layers by irradiating the plurality of first heat-sensitive recording layers with a first laser light beam, the first striped pattern extending in a first direction and having irregular widths.

10. The method of forming a drawing object according to claim 9, comprising
forming a second striped pattern on a second heat-sensitive recording layer by a recording method different from a recording method of each of the first heat-sensitive recording layers by irradiating the second heat-sensitive recording layer with a second laser light beam, wherein
the drawing object further includes the second heat-sensitive recording layer different from each of the first heat-sensitive recording layers in recording method.

11. The method of forming a drawing object according to claim 9, comprising drawing the first striped pattern on each of the plurality of first heat-sensitive recording layers to allow, in a spatial frequency spectrum of image data obtained by performing imaging of the first striped pattern with use of ring illumination, a profile in a second direction to include cyclical peaks not included in a profile in the first direction, the second direction being orthogonal to the first direction.

12. The method of forming a drawing object according to claim 9, comprising drawing the first striped pattern on each of the plurality of first heat-sensitive recording layers to allow an intensity ratio at a position of one of the peaks when the profile in the first direction and the profile in the second direction are overlapped with each other to satisfy the following expression,
S2/S1≥1.2
where
S1 is an intensity, of the profile in the first direction, at the position of the one of the peaks, and
S2 is an intensity, of the profile in the second direction, at the position of the one of the peaks.

13. The method of forming a drawing object according to claim 9, comprising
drawing the first striped pattern on each of the plurality of first heat-sensitive recording layers to allow the first direction to be a direction parallel to a first end side of the stacked body and allow the second direction to be a direction parallel to a second end side of the stacked body, the second end side being orthogonal to the first end side, wherein
the stacked body comprises a sheet-shaped or plate-shaped stacked body having a quadrangular shape in plan view.

14. The method of forming a drawing object according to claim 9, comprising
drawing the first striped pattern on each of the plurality of first heat-sensitive recording layers to allow each of the first direction and the second direction to be a direction obliquely intersecting with all end sides of the stacked body, wherein
the stacked body comprises a sheet-shaped or plate-shaped stacked body having a quadrangular shape in plan view.

15. The method of forming a drawing object according to claim 9, comprising
forming the first striped pattern on each of the plurality of first heat-sensitive recording layers as the drawing mark by irradiating the plurality of first heat-sensitive recording layers with the first laser light beam to cause photothermal conversion agents to generate heat and thereby cause the coloring compounds to develop colors, wherein
the respective first heat-sensitive recording layers include the photothermal conversion agents different from each other in the light absorption wavelength band.

16. The method of forming a drawing object according to claim 9, comprising continuously irradiating the plurality of first heat-sensitive recording layers with the first laser light beam in a scanning direction.

17. A drawing object, comprising
a stacked body including a plurality of heat-sensitive recording layers stacked with a heat-insulating layer interposed between the plurality of heat-sensitive recording layers, the plurality of heat-sensitive recording layers being different from each other in color in a color-developed state and light absorption wavelength band, wherein
the plurality of heat-sensitive recording layers each has a striped pattern drawn as a drawing mark resulting from irradiating a surface of the stacked body with a laser light beam, the striped pattern extending in a first direction and having irregular widths.

18. A method of forming a drawing object, the method comprising:
preparing a drawing object including a stacked body including a plurality of heat-sensitive recording layers stacked with a heat-insulating layer interposed between the plurality of heat-sensitive recording layers, the plurality of heat-sensitive recording layers being different from each other in color in a color-developed state and light absorption wavelength band; and
forming the drawing object by irradiating the stacked body with a laser light beam to form, as a drawing mark, a striped pattern on each of the plurality of heat-sensitive recording layers, the striped pattern extending in a first direction and having irregular widths.
